(19) United States
(12) Patent Application Publication
(10) Pub. No.: US 2012/0208035 A1
(43) Pub. Date: Aug. 16, 2012

(54) AQUEOUS COATING COMPOSITION

(76) Inventors: Toru Iwamoto, Hiratsuka-shi (JP); Chihiro Nagano, Hiratsuka-shi (JP); Takashi Nakayabu, Hiratsuka-shi (JP); Keiji Sugamoto, Hiratsuka-shi (JP); Hideo Sugai, Hiratsuka-shi (JP)

(21) Appl. No.: 13/499,814

(22) PCT Filed: Sep. 29, 2010
(86) PCT No.: PCT/JP2010/067499

§ 371 Date: Apr. 2, 2012

(30) Foreign Application Priority Data
Oct. 2, 2009 (JP) 2009-231042
Aug. 23, 2010 (JP) 2010-186626

(51) Int. Cl. B32B 27/20; C08K 5/05; C08K 5/08; B05D 1/36; C08K 5/3417

(52) U.S. Cl. 428/457; 427/419.1; 524/88; 524/358; 524/385

(57) ABSTRACT

An object of the present invention is to provide an aqueous coating composition comprising an (A) aluminium pigment treated with molybdic acid and a (B) condensed polycyclic pigment. The aqueous coating composition can achieve a small difference between the color of a coating film formed by application of the coating composition after storage and a color of the coating film formed by application of the coating composition before storage. The aqueous coating composition of the present invention inhibits hydrogen gas generation, and thus has excellent storage stability.

The present invention provides an aqueous coating composition, comprising:

(A) aluminium pigment treated with molybdic acid;
(B) condensed polycyclic pigment;
(C) resin having an aromatic ring with a nitro group bonded thereto; and
(D) film-forming resin.

### CROSS-REFERENCE TO RELATED APPLICATIONS

This application claims priority to JP Application No. 2009-231042, filed Oct. 2, 2009, and JP Application No. 2010-186626, filed Aug. 23, 2010, the disclosure of which is incorporated herein by reference in its entirety.

### TECHNICAL FIELD

The present invention relates to an aqueous coating composition and a method for forming a coating film using the aqueous coating composition.

### BACKGROUND ART

Top coating compositions, which are applied to exterior panels of automobiles, electric products, etc., are required to have a capability of forming a topcoat film with high-grade aesthetics. To meet this requirement, a coating composition containing an aluminium pigment has been developed.

The aluminium pigment is generally in the form of laminar flakes; and is oriented, in a coating film, parallel with respect to the surface of an object to which the coating film is coated, enabling formation of a coating film with characteristic aesthetics, i.e., having brilliant luster and different color tones depending on the viewing angle.

Heretofore, organic solvent-based coating compositions had mainly been used as a coating composition containing an aluminium pigment. However, since organic solvents evaporate during the baking of applied compositions and cause environmental pollution, aqueous coating compositions, which produce less environmental pollution, have been increasingly employed in recent years.

However, an aqueous coating composition containing an aluminium pigment has a problem in that the aluminium pigment is brought into contact with a large amount of the water in the coating composition, and corrodes to undesirably generate hydrogen gas.

In order to solve this problem, the use of, as the above-mentioned aluminium pigment, an aluminium pigment treated with molybdic acid has been proposed.

For example, Patent Literature 1 (PTL 1) teaches an aqueous aluminium pigment having a particulate structure, in which each of the aluminium flakes is surface-coated with a molybdic acid coating film in an amount of 0.1 to 10 wt % on a molybdenum metal basis based on the aluminum.

Patent Literature 2 (PTL 2) discloses an aluminium pigment characterized in that each of the aluminium flakes has thereon a molybdic acid coating film in an amount of 0.1 to 10 wt % on a molybdenum metal basis based on the aluminum; and further has, on the molybdic acid coating film, a phosphoric acid coating film in an amount of 0.05 to 1 wt % on a phosphorus element basis based on the aluminum, the phosphoric acid coating film comprising an inorganic phosphoric acid or a salt thereof, or an organic phosphate ester having one phosphate group or a salt thereof.

Patent Literature 3 (PTL 3) teaches an aluminium pigment comprising aluminum particles, a molybdenum coating film comprising a molybdenum oxide and/or a molybdenum hydrate, covering the surface of each of the aluminum particles, and a silica coating film comprising amorphous silica, further covering the molybdenum coating film.

The above-mentioned aqueous coating compositions comprising the aluminium pigment treated with molybdic acid generally inhibit a reaction between the aluminium pigment and water, due to the molybdic acid present in the aluminium pigment surface. Therefore, such aqueous coating compositions inhibit hydrogen gas generation during storage, and are thus excellent in storage stability.

The above-mentioned top coating composition usually further contains a coloring pigment to achieve various design aesthetics (e.g., Patent Literature 4). Generally, coloring pigments used for a top coating composition are mostly organic pigments. This is because organic pigments have various color types, a vivid hue and a high coloring power, compared to inorganic pigments, and are thus suitable for achieving design aesthetics that are required for a top coating composition.

Examples of organic pigments include phthalocyanine pigments, anthraquinone pigments, quinacridone pigments, indigo pigments, dioxazine pigments, perylene pigments, perinone pigments, isoindolinone pigments, isoindoline pigments, quinophthalone pigments, diketopyrrolopyrrole pigments, and like condensed polycyclic pigments; condensed azo pigment, insoluble azo pigments, soluble azo pigments, and like azo pigments; and the like.

Of these, when a phthalocyanine pigment is used in an aqueous coating composition, together with the above-mentioned aluminium pigment treated with molybdic acid, a coating film formed by application of the coating composition after storage for a certain period of time may have a color that is different from the color of a coating film formed by application of the coating composition before storage.

Further, many of the condensed polycyclic pigments contain ketone structures; among them, when a condensed polycyclic pigment having two or more ketone structures per molecule is used in an aqueous coating composition, together with the above-mentioned aluminium pigment treated with molybdic acid, a coating film formed by application of the coating composition after storage for a certain period of time may have a color that is different from the color of a coating film formed by application of the coating composition before storage.

### CITATION LIST

### Patent Literature

PTL 1: Japanese Unexamined Patent Publication No. 1994-57171
PTL 2: Japanese Unexamined Patent Publication No. 1995-70468
PTL 3: WO 2004/096921
PTL 4: Japanese Unexamined Patent Publication No. 2003-88801

### SUMMARY OF INVENTION

### Technical Problem

An object of the present invention is to provide an aqueous coating composition comprising an aluminium pigment treated with molybdic acid, and a condensed polycyclic pigment, the aqueous coating composition being able to achieve a small difference between the color of a coating film formed by application of the coating composition after storage and the color of a coating film formed by application of the coating composition before storage, the aqueous coating composition inhibiting hydrogen gas generation and thus being excellent in storage stability.

### Solution to Problem

The present inventors conducted extensive research to achieve the above object. As a result, the inventors found that an aqueous coating composition comprising an aluminium pigment treated with molybdic acid, a condensed polycyclic pigment, a resin having an aromatic ring with a nitro group bonded thereto, and a film-forming resin, can achieve a small difference between the color of a coating film formed by application of the coating composition after storage and the color of a coating film formed by application of the coating composition before storage. The present inventors further found that the above-mentioned aqueous coating composition inhibits hydrogen gas generation, and is thus excellent in storage stability.

Specifically, the present invention provides the following aqueous coating composition, method for forming a multilayer coating film using the aqueous coating composition, and article coated with the aqueous coating composition.

Item 1. An aqueous coating composition, comprising:
(A) aluminium pigment treated with molybdic acid;
(B) condensed polycyclic pigment;
(C) resin having an aromatic ring with a nitro group bonded thereto; and
(D) film-forming resin,

wherein:
(B) condensed polycyclic pigment is (B1) phthalocyanine pigment or (B2) condensed polycyclic pigment having two or more ketone structures per molecule.
   Item 2. The aqueous coating composition according to Item 1, wherein the (B1) phthalocyanine pigment is at least one phthalocyanine pigment selected from the group consisting of α-copper phthalocyanine pigments, β-copper phthalocyanine pigments, ε-copper phthalocyanine pigments, and cobalt phthalocyanine pigments.
   Item 3. The aqueous coating composition according to Item 1, wherein the (B2) condensed polycyclic pigment having two or more ketone structures per molecule is an anthraquinone pigment and/or a perylene pigment.
   Item 4. The aqueous coating composition according to any one of Items 1 to 3, wherein the (C) resin having an aromatic ring with a nitro group bonded thereto is a copolymer that is obtainable by copolymerization of monomer components comprising (a) polymerizable unsaturated monomer represented by Formula (1) below,

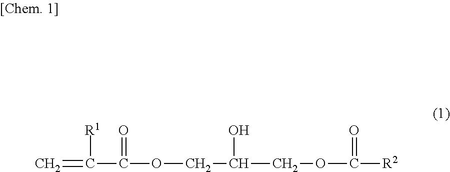

wherein R¹ represents a hydrogen atom or a methyl group; and R² represents an aromatic ring having a nitro group bonded thereto,

and (b) one or more other polymerizable unsaturated monomers.

Item 5. The aqueous coating composition according to Item 4,

wherein the (a) polymerizable unsaturated monomer is a polymerizable unsaturated monomer represented by Formula (2) below,

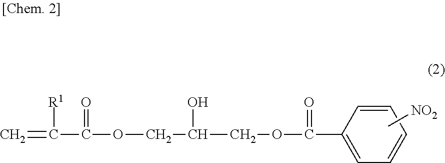

wherein R¹ represents a hydrogen atom or a methyl group.

Item 6. The aqueous coating composition according to Item 4 or 5, wherein a mass ratio of the (a) polymerizable unsaturated monomer to the (b) one or more other polymerizable unsaturated monomers is in a range of from 5/95 to 60/40.
Item 7. The aqueous coating composition according to any one of Items 4 to 6, wherein the (b) one or more other polymerizable unsaturated monomers comprise, as a part thereof, a polymerizable unsaturated monomer having a polyoxyalkylene chain in an amount of 5 to 50 mass % based on the total amount of the (a) polymerizable unsaturated monomer and the (b) one or more other polymerizable unsaturated monomers.
Item 8. The aqueous coating composition according to any one of Items 1 to 7, wherein the proportion of the (A) aluminium pigment treated with molybdic acid is 0.1 to 80 parts by mass, the proportion of the (B) condensed polycyclic pigment is 0.01 to 40 parts by mass, and the proportion of the (C) resin having an aromatic ring with a nitro group bonded thereto is 0.1 to 30 parts by mass, all based on 100 parts by mass of the (D) film-forming resin.
Item 9. The aqueous coating composition according to any one of Items 1 to 8, further comprising (E) curing agent.
Item 10. The aqueous coating composition according to any one of Items 1 to 9, further comprising (F) phthalocyanine pigment derivative.
Item 11. An article coated with the aqueous coating composition according to any one of Items 1 to 10.
Item 12. A method for forming a multilayer coating film, comprising the steps of:

(1) applying the aqueous coating composition of any one of Items 1 to 10 to a substrate to form a base coating film;

(2) applying a clear coating composition on an uncured base coating film to form a clear coating film; and

(3) heating the uncured base coating film and an uncured clear coating film to simultaneously cure both coating films.

Item 13. An article having a multilayer coating film formed by the method for forming a multilayer coating film of Item 12.

### Advantageous Effects of Invention

The aqueous coating composition of the present invention comprising an aluminium pigment (A) treated with molybdic acid, a condensed polycyclic pigment (B), a resin (C) having an aromatic ring with a nitro group bonded thereto, and a film-forming resin (D), can achieve a small difference between the color of a coating film formed by application of the coating composition after storage and the color of a coating film formed by application of the coating composition before storage. Further, the aqueous coating composition of the present invention inhibits hydrogen gas generation, and thus has excellent storage stability.

### DESCRIPTION OF EMBODIMENTS

Hereinafter, the aqueous coating composition of the present invention is described in detail.

The aqueous coating composition of the present invention comprises an aluminium pigment (A) treated with molybdic acid, a condensed polycyclic pigment (B), a resin (C) having an aromatic ring with a nitro group bonded thereto, and a film-forming resin (D).

Aluminium Pigment (A) Treated with Molybdic Acid

The aluminium pigment (A) treated with molybdic acid can generally be prepared by subjecting an aluminium pigment to a surface treatment using molybdic acid; molybdate; hydrate molybdate; a reaction product of molybdic acid or molybdate, and an amine compound; a reaction product of anhydrous molybdic acid or a hydrate thereof, and an amine compound; or the like.

Examples of the aluminium pigments (A) treated with molybdic acid include, but are not limited to, those known in the art, such as an aluminium pigment having a particulate structure and coated with molybdic acid in an amount of 0.1 to 10 wt % on a molybdenum metal basis based on the aluminum (Japanese Unexamined Patent Publication No. 1994-57171); an aluminium pigment having a phosphoric acid coating film in addition to a molybdic acid coating film (Japanese Unexamined Patent Publication No. 1995-70468); an aluminium pigment having a phosphate coating film in addition to a molybdic acid coating film (Japanese Unexamined Patent Publication No. 1995-133440); an aluminium pigment having a coating film formed from peroxo-polymolybdate, and containing a specific amine (WO 2002/031061); an aluminium pigment having a silica film in addition to a molybdic acid coating (WO 2004/096921); an aluminium pigment comprising a reaction product of an amine compound and an inorganic molybdenum compound selected from molybdenum trioxide (anhydrous molybdic acid) or a hydrate thereof, and a molybdic acid or an alkali salt thereof (Japanese Unexamined Patent Publication No. 2007-169613); an aluminium pigment surface-treated with phospho(tungsto)molybdic acid amine salt, phospho(vanado)molybdic acid amine salt, or the like (WO 2008/059839); and the like.

Commercially available products can also be used as the aluminium pigment (A) treated with molybdic acid. Examples of the commercially available products used as the aluminium pigment (A) treated with molybdic acid include WJ series, WL series, and the like, produced by Toyo Aluminium K.K.

The aluminium pigment (A) treated with molybdic acid generally has molybdic acid on the surface of the aluminium pigment. The molybdic acid on the surface of the aluminium pigment suppresses hydrogen gas generation caused by a reaction of the water and aluminium pigment in the aqueous coating composition. For this reason, the aqueous coating composition of the present invention containing aluminium pigment (A) treated with molybdic acid is excellent in storage stability. The molybdic acid on the surface of the aluminium pigment may be present on the entire surface of the aluminium pigment, or may be scattered on the surface of the aluminium pigment.

The aluminium pigment (A) treated with molybdic acid is preferably in the form of flakes. More specifically, the preferable aluminium pigment (A) treated with molybdic acid has a longitudinal dimension of about 1 to about 100 μm, preferably about 5 to about 40 μm; and a thickness of about 0.001 to about 5 μm, preferably about 0.01 to about 2 μm.

The aluminium pigment (A) treated with molybdic acid preferably contains molybdenum in an amount of 0.02 to 15 parts by mass, more preferably 0.05 to 12 parts by mass, further preferably 0.1 to 10 parts by mass, on a metallic molybdenum basis, per 100 parts by mass of the aluminum.

### Condensed Polycyclic Pigment (B)

The aqueous coating composition of the present invention comprises a condensed polycyclic pigment (B). Usable as the condensed polycyclic pigment (B) are a phthalocyanine pigment (B1) and a condensed polycyclic pigment (B2) having two or more ketone structures per molecule. The aqueous coating composition of the present invention encompasses a composition containing either one of the phthalocyanine pigment (B1) or the condensed polycyclic pigment (B2) having two or more ketone structures per molecule, and a composition containing both of the above.

### Phthalocyanine Pigment (B1)

The phthalocyanine pigment (B1) is a pigment having a phthalocyanine skeleton, and known phthalocyanine pigments can be used without particular limitation. The phthalocyanine pigment (B1) may be a metal phthalocyanine pigment or a metal-free phthalocyanine pigment.

A metal phthalocyanine pigment contains metal at the center of the phthalocyanine skeleton. Examples of the metals at the center of the phthalocyanine skeleton include copper, nickel, cobalt, zinc, iron, silver, beryllium, magnesium, calcium, aluminum, indium, sodium, lithium, titanium, tin, lead, vanadium, chromium, manganese, and the like. Among these metals, the phthalocyanine pigment (B1) is preferably a copper phthalocyanine pigment comprising copper as the central metal of the phthalocyanine skeleton, and/or a cobalt phthalocyanine pigment comprising cobalt as the central metal of the phthalocyanine skeleton. The phthalocyanine pigment (B1) is more preferably a copper phthalocyanine pigment.

In the phthalocyanine pigment (B1), a part of the molecules may have a substituent. Specifically, halogenated copper phthalocyanine pigments substituted with a halogenated compound such as chlorine or bromine; fast sky blue in which a sulfonated copper phthalocyanine pigment is dyed onto an extender pigment such as an alumina white or barium sulfate, and laked with barium chloride; and the like, may be used.

In addition, the phthalocyanine pigment (B1) has crystal polymorphism. Specifically, crystal forms such as α, β, γ, δ, ε, π, ρ, τ, χ are known. In the present invention, there is no particular limitation to the crystal forms of the phthalocyanine pigment (B1). However, in the aqueous coating composition of the present invention, considering the large effect on the improvement in storage stability, the phthalocyanine pigment (B1) preferably has a crystal form selected from α-, β-, γ-, and ε-types. Of these, the phthalocyanine pigment (B1) preferably has an α-, β-, or ε-type crystal form, and more preferably an α-type crystal form. More specifically, the phthalocyanine pigment (B1) is preferably at least one phthalocyanine pigment selected from the group consisting of α-copper phthalocyanine pigments, β-copper phthalocyanine pigments, and ε-copper phthalocyanine pigments. It is more preferable that the phthalocyanine pigment (B1) be an α-copper phthalocyanine pigment.

Specific examples of the phthalocyanine pigments (B1) include copper phthalocyanine pigments, such as C.I. pigment blue 15 (C.I. No. 74160), C.I. pigment blue 15:1 (C.I. No. 74160), C.I. pigment blue 15:2 (C.I. No. 74160), C.I. pigment blue 15:3 (C.I. No. 74160), C.I. pigment blue 15:4 (C.I. No. 74160), C.I. pigment blue 15:5 (C.I. No. 74160), C.I. pigment blue 15:6 (C.I. No. 74160), C.I. pigment blue 17:1 (C.I. No. 74180:1), C.I. pigment green 7 (C.I. No. 74260), C.I. pigment green 36 (C.I. No. 74265), C.I. pigment green 37 (C.I. No. 74255), C.I. pigment green 42 (C.I. No. 76260), and the like. These may be used singly, or in a combination of two or more.

Examples of the phthalocyanine pigments (B1) other than the above-exemplified copper phthalocyanine pigments include cobalt phthalocyanine pigments, such as C.I. pigment blue 75 (C.I. No. 74160:2); aluminium phthalocyanine pigments, such as C.I. pigment blue 79 (C.I. No. 761300); metal-free phthalocyanine pigments, such as C.I. pigment blue 16 (C.I. No. 74100); and the like. These may be used singly, or in a combination of two or more.

### Condensed Polycyclic Pigment (B-2) Having Two or More Ketone Structures Per Molecule

Examples of condensed polycyclic pigments (B2) having two or more ketone structures per molecule include anthraquinone pigments, quinacridone pigments, indigo pigments, perylene pigments, perinone pigments, isoindolinone pigments, isoindoline pigments, diketopyrrolopyrrole pigments, and the like. These may be used singly, or in a combination of two or more. Of these, anthraquinone pigments and/or perylene pigments are preferable, considering the large effect on reducing the difference between the color of a coating film formed by application of the coating composition after storage and the color of the coating film formed by application of the coating composition before storage.

Preferably used as the condensed polycyclic pigment (B-2) having two or more ketone structures per molecule are condensed polycyclic pigments having 2 to 6, preferably 2 to 4, and more preferably 4 ketone structures per molecule.

Examples of the anthraquinone pigments include C.I. pigment yellow 24 (C.I. No. 70600), C.I. pigment yellow 108 (C.I. No. 68420), C.I. pigment orange 51, C.I. pigment red 168 (C.I. No. 59300), C.I. pigment red 177 (C.I. No. 65300), C.I. pigment blue 60 (C.I. No. 69800), and the like. These may be used singly, or in a combination of two or more. Of these, C.I. pigment blue 60 (C.I. No. 69800) is preferably used, considering the large effect on reducing the difference between the color of a coating film formed by application of the coating composition after storage and the color of the coating film formed by application of the coating composition before storage.

Examples of quinacridone pigments include C.I. pigment violet 19 (C.I. No. 73900), C.I. pigment red 122 (C.I. No. 73915), C.I. pigment red 202 (C.I. No. 73907), C.I. pigment red 206 (C.I. No. 73900/73920), C.I. pigment red 207 (C.I. No. 73900/73906), C.I. pigment red 209 (C.I. No. 73905), C.I. pigment orange 48 (C.I. No. 73900/73920), and the like. These may be used singly, or in a combination of two or more.

Examples of indigo pigments include C.I. pigment blue 66 (C.I. No. 73000), C.I. pigment blue 63 (C.I. No. 73015:1), C.I. pigment red 88 (C.I. No. 73312), C.I. pigment red 181 (C.I. No. 73360), C.I. pigment brown 27 (C.I. No. 73410), and the like. These may be used singly, or in a combination of two or more.

Examples of perylene pigments include C.I. pigment red 123 (C.I. No. 71145), C.I. pigment red 149 (C.I. No. 71137), C.I. pigment red 178 (C.I. No. 71155), C.I. pigment red 179 (C.I. No. 71130), C.I. pigment red 190 (C.I. No. 71140), C.I. pigment red 224 (C.I. No. 71127), C.I. pigment violet 29 (C.I. No. 71129), C.I. pigment black 31 (C.I. No. 71132), C.I. pigment black 32 (C.I. No. 71133), and the like. These may be used singly, or in a combination of two or more. Of these, C.I. pigment red 179 (C.I. No. 71130) is preferably used, considering the large effect on reducing the difference between the color of a coating film formed by application of the coating composition after storage and the color of the coating film formed by application of the coating composition before storage.

Examples of perinone pigments include C.I. pigment orange 43 (C.I. No. 71105), C.I. pigment red 194 (C.I. No. 71100), and the like. These may be used singly, or in a combination of two or more.

Examples of isoindolinone pigments include C.I. pigment yellow 109 (C.I. No. 56284), C.I. pigment yellow 110 (C.I. No. 56280), C.I. pigment yellow 173, C.I. pigment orange 61 (C.I. No. 11265), and the like. These may be used singly, or in a combination of two or more.

Examples of isoindoline pigments include C.I. pigment yellow 139 (C.I. No. 56298), C.I. pigment yellow 185 (C.I. No. 56290), C.I. pigment orange 66 (C.I. No. 48210), C.I. pigment orange 69 (C.I. No. 56292), C.I. pigment red 260 (C.I. No. 56295), and the like. These may be used singly, or in a combination of two or more.

Examples of diketopyrrolopyrrole pigments include C.I. pigment orange 71, C.I. pigment orange 73, C.I. pigment red 254 (C.I. No. 56110), C.I. pigment red 255, C.I. pigment red 264, C.I. pigment red 270, C.I. pigment red 272, and the like. These may be used singly, or in a combination of two or more.

Resin (C) Having an Aromatic Ring with a Nitro Group Bonded Thereto

Preferably used as the resin (C) having an aromatic ring with a nitro group bonded thereto are specifically acrylic resins having an aromatic ring with a nitro group bonded thereto. Such acrylic resins having an aromatic ring with a nitro group bonded thereto can be obtained, for example, by (co)polymerization of a polymerizable unsaturated monomer having an aromatic ring with a nitro group bonded thereto and other polymerizable unsaturated monomer(s).

The polymerizable unsaturated monomer having an aromatic ring with a nitro group bonded thereto can be obtained, for example, by reacting a polymerizable unsaturated monomer having a glycidyl group and an aromatic carboxylic acid having a nitro group. Examples of the polymerizable unsaturated monomer having a glycidyl group include glycidyl(meth)acrylate, 2-methylglycidyl(meth)acrylate, 3-methylglycidyl(meth)acrylate, and the like. These may be used singly, or in a combination of two or more. Of these, glycidyl acrylate and glycidyl methacrylate are preferable, and glycidyl methacrylate is particularly preferable.

To provide an aqueous coating composition excellent in storage stability, it is preferable that the resin (C) having an aromatic ring with a nitro group bonded thereto be a copolymer that can be obtained by copolymerization of monomer components comprising a polymerizable unsaturated monomer (a) represented by Formula (1) below,

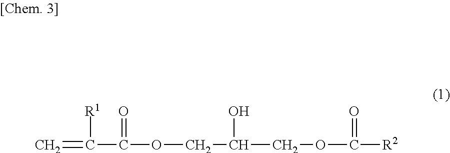

wherein R¹ represents a hydrogen atom or a methyl group; and R² represents an aromatic ring having a nitro group bonded thereto, and one or more other polymerizable unsaturated monomers (b).

Examples of R² in Formula (1) above include 2-nitrophenyl group, 3-nitrophenyl group, 4-nitrophenyl group, 2-hydroxy-4-nitrophenyl group, 2-methyl-4-nitrophenyl group, 3,5-dinitrophenyl group, and the like. Among them, 2-nitrophenyl group, 3-nitrophenyl group or 4-nitrophenyl group is preferable, and 4-nitrophenyl group is even more preferable.

### Polymerizable Unsaturated Monomer (a)

The polymerizable unsaturated monomer (a) is not particularly limited as long as it is a polymerizable unsaturated monomer represented by Formula (1) above.

The above-mentioned polymerizable unsaturated monomer (a) can be obtained, for example, by reacting glycidyl(meth)acrylate and an aromatic carboxylic acid having one or more nitro groups. Examples of the usable aromatic carboxylic acid having one or more nitro groups include 2-nitrobenzoic acid, 3-nitrobenzoic acid, 4-nitrobenzoic acid, 2-hydroxy-4-nitrobenzoic acid, 2-methyl-4-nitrobenzoic acid, 3,5-dinitrobenzoic acid, and the like.

The reaction between glycidyl(meth)acrylate and an aromatic carboxylic acid having a nitro group can be carried out, for example, by heating them in the presence of a tertiary amine and/or a quaternary ammonium salt at about 90 to about 160° C. for about 2 to about 10 hours.

Examples of usable tertiary amines mentioned above include tributylamine, N,N-dimethylbenzylamine, 2-(dimethylamino) ethanol, N-methyldiethanolamine, triethanolamine, etc. Examples of the above-mentioned usable quaternary ammonium salt include triethylbenzylammonium chloride, tetramethylammonium chloride, tetraethylammonium chloride, tetra-n-butylammonium chloride, tetraethylammonium bromide, tetra-n-butylammonium bromide, tetra-n-butylammonium iodide, and the like.

To provide an aqueous coating composition excellent in storage stability, preferably used as the polymerizable unsaturated monomer (a) are polymerizable unsaturated monomers represented by Formula (2) below,

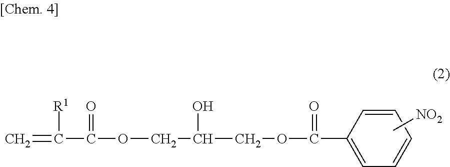

wherein R¹ represents a hydrogen atom or a methyl group. Of these, polymerizable unsaturated monomers represented by Formula (3) below,

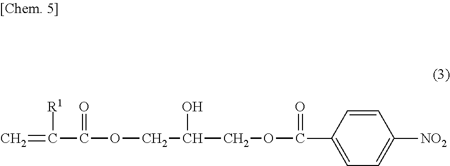

wherein R¹ represents a hydrogen atom or a methyl group, are more preferably used.

The polymerizable unsaturated monomer represented by Formula (2) shown above can generally be obtained by reacting glycidyl(meth)acrylate with either one of 2-nitrobenzoic acid, 3-nitrobenzoic acid and 4-nitrobenzoic acid. The polymerizable unsaturated monomers represented by Formula (3) shown above can generally be obtained by reacting glycidyl(meth)acrylate with 4-nitrobenzoic acid.

The polymerizable unsaturated monomer (a) may be a single component or a combination of two or more components.

### Other Polymerizable Unsaturated Monomer (b)

Other polymerizable unsaturated monomers (b) are polymerizable unsaturated monomers other than the polymerizable unsaturated monomer (a), and those that can be copolymerized with the monomer (a). Specific examples of the monomers are listed in (i) to (xx). These can be used singly, or in a combination of two or more.

(i) Alkyl or cycloalkyl(meth)acrylates: for example, methyl(meth)acrylate, ethyl(meth)acrylate, n-propyl(meth)acrylate, iso-propyl(meth)acrylate, n-butyl(meth)acrylate, iso-butyl(meth)acrylate, tert-butyl(meth)acrylate, n-hexyl(meth)acrylate, n-octyl(meth)acrylate, 2-ethylhexyl(meth)acrylate, nonyl(meth)acrylate, tridecyl(meth)acrylate, lauryl(meth)acrylate, stearyl(meth)acrylate, isostearyl(meth)acrylate, cyclohexyl(meth)acrylate, methylcyclohexyl(meth)acrylate, tert-butylcyclohexyl(meth)acrylate, cyclododecyl(meth)acrylate, tricyclodecanyl(meth)acrylate, etc.

(ii) Polymerizable unsaturated monomers having an isobornyl group: isobornyl(meth)acrylate, etc.

(iii) Polymerizable unsaturated monomers having an adamantyl group: adamantyl(meth)acrylate, etc.

(iv) Polymerizable unsaturated monomer having a tricyclodecenyl group: tricyclodecenyl(meth)acrylate, etc.

(v) Aromatic ring-containing polymerizable unsaturated monomers: benzyl(meth)acrylate, styrene, α-methyl styrene, vinyl toluene, etc.

(vi) Polymerizable unsaturated monomers having an alkoxysilyl group: vinyltrimethoxysilane, vinyltriethoxysilane, vinyltris(2-methoxyethoxy)silane, γ-(meth)acryloyloxypropyltrimethoxysilane, γ-(meth)acryloyloxypropyltriethoxysilane, etc.

(vii) Polymerizable unsaturated monomers having a fluorinated alkyl group: perfluoroalkyl(meth)acrylates such as perfluorobutylethyl(meth)acrylate and perfluorooctylethyl(meth)acrylate; fluoroolefin; etc.

(viii) Polymerizable unsaturated monomers having a photopolymerizable functional group such as a maleimide group.

(ix) Vinyl compounds: N-vinylpyrrolidone, ethylene, butadiene, chloroprene, vinyl propionate, vinyl acetate, etc.

(x) Hydroxy-containing polymerizable unsaturated monomers: 2-hydroxyethyl(meth)acrylate, 2-hydroxypropyl(meth)acrylate, 3-hydroxypropyl(meth)acrylate, 4-hydroxybutyl(meth)acrylate, and like monoesterified products of (meth)acrylic acid with a dihydric alcohol containing 2 to 8 carbon atoms, ε-caprolactone-modified products of the monoesterified products, N-hydroxymethyl(meth)acrylamide, allyl alcohol, and (meth)acrylate having a polyoxyethylene chain with a terminal hydroxyl group.

(xi) Carboxy-containing polymerizable unsaturated monomers: (meth)acrylic acid, maleic acid, crotonic acid, β-carboxyethyl acrylate, etc.

(xii) Nitrogen-containing polymerizable unsaturated monomers other than the polymerizable unsaturated monomer (a): (meth)acrylonitrile, (meth)acrylamide, N,N-dimethylaminoethyl(meth)acrylate, N,N-diethylaminoethyl(meth)acrylate, N,N-dimethylaminopropyl(meth)acrylamide, methylene bis(meth)acrylamide, ethylene bis(meth)acrylamide, 2-(methacryloyloxy)ethyl trimethylammonium chloride, adducts of glycidyl(meth)acrylate with amine compounds, etc.

(xiii) Polymerizable unsaturated monomers having two or more polymerizable unsaturated groups per molecule: allyl(meth)acrylate, 1,6-hexanediol di(meth)acrylate, etc.

(xiv) Epoxy-containing polymerizable unsaturated monomers: glycidyl(meth)acrylate, β-methylglycidyl(meth)acrylate, 3,4-epoxycyclohexylmethyl(meth)acrylate, 3,4-epoxycyclohexylethyl(meth)acrylate, 3,4-epoxycyclohexylpropyl(meth)acrylate, allyl glycidyl ether, etc.

(xv) (Meth)acrylates having alkoxy-terminated polyoxyethylene chains.

(xvi) Sulfonic acid group-containing polymerizable unsaturated monomers: 2-acrylamide-2-methylpropanesulfonic acid, 2-sulfoethyl(meth)acrylate, allylsulfonic acid, 4-styrenesulfonic acid, etc.; sodium salts and ammonium salts of such sulfonic acids; etc.

(xvii) Phosphoric acid group-containing polymerizable unsaturated monomers: acid phosphooxyethyl(meth)acrylate, acid phosphooxypropyl(meth)acrylate, acid phosphooxypoly(oxyethylene)glycol(meth)acrylate, acid phosphooxypoly(oxypropylene)glycol(meth)acrylate, etc.

(xviii) Polymerizable unsaturated monomers having an ultraviolet-absorbing functional group: 2-hydroxy-4-(3-methacryloyloxy-2-hydroxypropoxy)benzophenone, 2-hydroxy-4-(3-acryloyloxy-2-hydroxypropoxy)benzophenone, 2,2′-dihydroxy-4-(3-methacryloyloxy-2-hydroxypropoxy)benzophenone, 2,2′-dihydroxy-4-(3-acryloyloxy-2-hydroxypropoxy)benzophenone, 2-(2′-hydroxy-5′-methacryloyloxyethylphenyl)-2H-benzotriazole, etc.

(xix) UV-stable polymerizable unsaturated monomers: 4-(meth)acryloyloxy-1,2,2,6,6-pentamethylpiperidine, 4-(meth)acryloyloxy-2,2,6,6-tetramethylpiperidine, 4-cyano-4-(meth)acryloylamino-2,2,6,6-tetramethylpiperidine, 1-(meth)acryloyl-4-(meth)acryloylamino-2,2,6,6-tetramethylpiperidine, 1-(meth)acryloyl-4-cyano-4-(meth)acryloylamino-2,2,6,6-tetramethylpiperidine, 4-crotonoyloxy-2,2,6,6-tetramethylpiperidine, 4-crotonoylamino-2,2,6,6-tetramethylpiperidine, 1-crotonoyl-4-crotonoyloxy-2,2,6,6-tetramethylpiperidine, etc.

(xx) Carbonyl-containing polymerizable unsaturated monomers: acrolein, diacetone acrylamide, diacetone methacrylamide, acetoacetoxylethyl methacrylate, formylstyrol, vinyl alkyl ketones having 4 to 7 carbon atoms (e.g., vinyl methyl ketone, vinyl ethyl ketone, vinyl butyl ketone), etc.

The term “polymerizable unsaturated group” in this specification means an unsaturated group that can undergo radical polymerization. Examples of such a polymerizable unsaturated group include a vinyl group and a (meth)acryloyl group, etc.

The term “(meth)acrylate” used in this specification means “acrylate or methacrylate”. The term “(meth)acrylic acid” means “acrylic acid or methacrylic acid”, and the term “(meth)acryloyl” means “acryloyl or methacryloyl”. Additionally, the term “(meth)acrylamide” means “acrylamide or methacrylamide”.

The other polymerizable unsaturated monomer (b) preferably contains, as at least part of the component, a polymerizable unsaturated monomer having a polyoxyalkylene chain to improve the storage stability of the aqueous coating composition.

The above-mentioned polymerizable unsaturated monomer having a polyoxyalkylene chain is a monomer containing a polyoxyalkylene chain and a polymerizable unsaturated group per molecule, and can impart hydrophilicity to the formed resin (C) mentioned above.

Examples of the polyoxyalkylene chain include a polyoxyethylene chain, a polyoxypropylene chain, a chain that includes a polyoxyethylene block and a polyoxypropylene block, and a chain that includes randomly linked polyoxyethylene and polyoxypropylene. The polyoxyalkylene chain preferably has a molecular weight of generally about 200 to about 5,000, preferably about 500 to about 4,000, further preferably about 800 to about 3,000.

Typical examples of the polymerizable unsaturated monomers having a polyoxyalkylene chain include polymerizable unsaturated monomers represented by Formula (4) below,

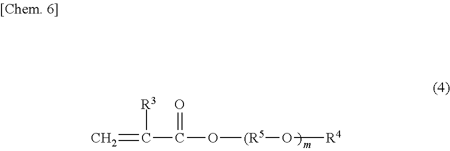

wherein R³ represents a hydrogen atom or a methyl group; R⁴ represents a hydrogen atom or an alkyl group having 1 to 4 carbon atoms; R⁵ represents an alkylene group having 2 to 4, preferably 2 or 3, more preferably 2 carbon atoms; m represents an integer of from 3 to 150, preferably 10 to 80, and even more preferably 25 to 50; and m oxyalkylene units (R⁵—O) may be the same or different from each other.

Specific examples the polymerizable unsaturated monomers represented by Formula (4) shown above include tetraethylene glycol(meth)acrylate, methoxytetraethylene glycol(meth)acrylate, ethoxytetraethylene glycol(meth)acrylate, n-butoxytetraethylene glycol(meth)acrylate, tetrapropylene glycol(meth)acrylate, methoxytetrapropylene glycol(meth)acrylate, ethoxytetrapropylene glycol(meth)acrylate, n-butoxytetrapropylene glycol(meth)acrylate, polyethylene glycol(meth)acrylate, polypropylene glycol(meth)acrylate, methoxypolyethylene glycol(meth)acrylate, ethoxypolyethylene glycol(meth)acrylate, etc. These can be used singly or in a combination of two or more. Among them, polyethylene glycol(meth)acrylate, polypropylene glycol(meth)acrylate, methoxypolyethylene glycol(meth)acrylate and ethoxypolyethylene glycol(meth)acrylate are preferable, and methoxypolyethylene glycol(meth)acrylate and ethoxypolyethylene glycol(meth)acrylate are particularly preferable.

The above-mentioned polymerizable unsaturated monomer having a polyoxyalkylene chain generally has a molecular weight of about 300 to about 6,000, preferably about 600 to about 5,000, and more preferably about 900 to about 3,500.

The amount of the polymerizable unsaturated monomer having a polyoxyalkylene chain used is preferably about 5 to about 50 mass %, more preferably about 10 to about 40 mass %, and even more preferably about 15 to 30 mass %, based on the total mass of the polymerizable unsaturated monomer (a) and the other polymerizable unsaturated monomer(s) (b).

The other polymerizable unsaturated monomer (b) preferably contains, as at least part of the component, an aromatic ring-containing polymerizable unsaturated monomer, to improve the storage stability of the coating composition.

Specific examples of the aromatic ring-containing polymerizable unsaturated monomers are as listed in (v) above. It is preferable to use styrene as the aromatic ring-containing polymerizable unsaturated monomer.

The amount of the aromatic ring-containing polymerizable unsaturated monomer used is preferably about 1 to about 50 mass %, more preferably about 3 to about 40 mass %, and even more preferably about 5 to about 30 mass %, based on the total mass of the polymerizable unsaturated monomer (a) and the other polymerizable unsaturated monomer(s) (b).

It is desirable that the resin (C) having an aromatic ring with a nitro group bonded thereto reacts with the after-mentioned film forming resin (D) and/or curing agent (E), such as an amino resin, a blocked or unblocked polyisocyanate compound, an oxazoline group-containing compound, and a carbodiimide-containing compound, and is incorporated into the cross-linked cured coated film in view of the performance of the coated film in, for example, water resistance. Therefore, the other polymerizable unsaturated monomer (b) preferably contains a hydroxy-containing polymerizable unsaturated monomer and/or a carboxy-containing polymerizable unsaturated monomer as at least part thereof, and even more preferably contains a hydroxy-containing polymerizable unsaturated monomer.

Specific examples of the hydroxy-containing polymerizable unsaturated monomer are as listed in (x) above. Preferably used hydroxy-containing polymerizable unsaturated monomers are 2-hydroxyethyl(meth)acrylate, 4-hydroxybutyl(meth)acrylate, ε-caprolactone-modified products of 2-hydroxyethyl(meth)acrylate, etc. Among them, it is more preferable to use 2-hydroxyethyl(meth)acrylate.

The amount of hydroxy-containing polymerizable unsaturated monomer used is preferably about 1 to about 40 mass %, more preferably about 3 to about 30 mass %, and even more preferably about 5 to about 20 mass %, based on the total mass of the polymerizable unsaturated monomer (a) and the other polymerizable unsaturated monomer(s) (b).

The other polymerizable unsaturated monomer (b) can contain a carboxy-containing polymerizable unsaturated monomer as at least a part thereof.

Specific examples of the carboxy-containing polymerizable unsaturated monomer are as listed in (xi) above. It is particularly preferable to use (meth)acrylic acid, etc., as the carboxy-containing polymerizable unsaturated monomer.

When the carboxy-containing polymerizable unsaturated monomer is used as a part of the other polymerizable unsaturated monomer (b), the amount of the carboxy-containing polymerizable unsaturated monomer used is preferably about 1 to about 20 mass %, more preferably about 2 to about 15 mass %, and even more preferably about 3 to about 10 mass %, based on the total mass of the polymerizable unsaturated monomer (a) and the other polymerizable unsaturated monomer(s) (b).

The other polymerizable unsaturated monomer (b) preferably contains a polymerizable unsaturated monomer having an alkyl group having 1 or 2 carbon atoms, as at least part thereof, to improve the storage stability of the coating composition.

Examples of the polymerizable unsaturated monomer having an alkyl group having 1 or 2 carbon atoms include methyl(meth)acrylate and ethyl(meth)acrylate. These monomers can be used singly or in a combination of two or more.

Preferably used as the above-mentioned polymerizable unsaturated monomer having an alkyl group having 1 or 2 carbon atoms, is methyl methacrylate, in order to improve the storage stability of the coating composition.

The amount of the above-mentioned polymerizable unsaturated monomer having an alkyl group having 1 or 2 carbon atoms, used is preferably about 5 to about 70 mass %, more preferably about 10 to about 60 mass %, and even more preferably about 15 to about 50 mass %, based on the total mass of the polymerizable unsaturated monomer (a) and the other polymerizable unsaturated monomer(s) (b).

The resin (C) having an aromatic ring with a nitro group bonded thereto can be obtained, for example, by copolymerization of the polymerizable unsaturated monomer (a) and the other polymerizable unsaturated monomer(s) (b). The amounts of the polymerizable unsaturated monomer (a) and the other polymerizable unsaturated monomer(s) (b) used in the copolymerization are such that the mass ratio of the polymerizable unsaturated monomer (a)/the other polymerizable unsaturated monomer(s) (b) is preferably about 5/95 to about 60/40, more preferably about 10/90 to about 40/60, and even more preferably about 15/85 to about 30/70, to improve the luster (flip-flop property) of the coating composition.

Generally, a coating film with good luster is one in which the metallic appearance changes over a wide range depending on the viewing angle of the coating film, and in which the luster pigment in the coating film is relatively uniform, thus producing hardly any metallic mottling. Coating films that exhibit such large changes in the metallic appearance depending on the viewing angle are generally described as having a high flip-flop property.

The copolymerization of the polymerizable unsaturated monomer (a) and the other polymerizable unsaturated monomer(s) (b) can be performed, for example, by using a known method, such as solution polymerization in an organic solvent or a mixed solution of an organic solvent and water, or emulsion polymerization in a water medium. Among these, solution polymerization is preferable.

When employed, solution polymerization can be carried out, for example, by dissolving or dispersing the polymerizable unsaturated monomer (a), the other polymerizable unsaturated monomer(s) (b) and a radical polymerization initiator in an organic solvent or a organic solvent-water mixed solution prepared by dissolving water in an organic solvent, and then heating the solution or dispersion normally at a temperature of about 80 to about 180° C. for about 2 to about 10 hours with stirring to perform copolymerization.

Examples of the organic solvents that can be used in the above-mentioned copolymerization reaction include heptane, toluene, xylene, octane, mineral spirits and like hydrocarbon solvents; ethyl acetate, n-butyl acetate, isobutyl acetate, ethylene glycol monomethyl ether acetate, diethylene glycol monobutyl ether acetate and like ester solvents; methyl ethyl ketone, methyl isobutyl ketone, diisobutyl ketone, cyclohexanone and like ketone solvents; methanol, ethanol, isopropanol, n-butanol, sec-butanol, isobutanol and like alcohol solvents; n-butyl ether, dioxane, ethylene glycol monomethyl ether, ethylene glycol monobutyl ether, propylene glycol monomethyl ether, propylene glycol monopropyl ether, propylene glycol monobutyl ether, dipropylene glycol monomethyl ether, dipropylene glycol monobutyl ether, tripropylene glycol monomethyl ether and like ether solvents; N,N-dimethylacetamide, N,N-dimethylformamide, N-methyl-2-pyrrolidone, N,N-dimethyl-β-methoxy propionamide and like amide solvents; 1,3-dimethyl-2-imidazolidinone and like urea solvents; dimethyl sulfoxide and like sulfoxide solvents; tetramethylene sulfone and like sulfone solvents; “Swazol 310”, “Swazol 1000”, “Swazol 1500” (tradenames, Maruzen Petrochemical) and like aromatic petroleum solvents, etc. These organic solvents can be used singly or in a combination of two or more. The amount of the organic solvent used in the solution polymerization is generally about 20 to about 400 parts by mass, preferably about 30 to 200 parts by mass, per 100 parts by mass of the total amount of the monomers (a) and (b).

Examples of radical polymerization initiators include cyclohexanone peroxide, 3,3,5-trimethylcyclohexanone peroxide, methylcyclohexanone peroxide and like ketone peroxide compounds; 1,1-bis(tert-butylperoxy)-3,3,5-trimethyl cyclohexane, 1,1-bis(tert-butylperoxy)cyclohexane, n-butyl-4,4-bis(tert-butylperoxy)valerate and like peroxy ketal compounds; cumene hydroperoxide, 2,5-dimethylhexane-2,5-dihydroperoxide and like hydroperoxide compounds; 1,3-bis(tert-butylperoxy-m-isopropyl)benzene, 2,5-dimethyl-2,5-di(tert-butylperoxy)hexane, diisopropylbenzene peroxide, tert-butyl cumyl peroxide and like dialkyl peroxide compounds; decanoyl peroxide, lauroyl peroxide, benzoyl peroxide, 2,4-dichlorobenzoyl peroxide and like diacyl peroxide compounds; bis(tert-butylcyclohexyl)peroxy dicarbonate and like peroxy carbonate compounds; organic peroxide polymerization initiators such as tert-butyl peroxybenzoate, 2,5-dimethyl-2,5-di(benzoylperoxy)hexane and like peroxyester compounds; 2,2′-azobisisobutyronitrile, 2,2′-azobis(2-methylpropanoic acid methyl) (otherwise known as Dimethyl-2,2′-azobisisobutyrate), 1,1-azobis(cyclohexane-1-carbonitrile), azocumene-2,2′-azobismethylvaleronitrile, 4,4′-azobis(4-cyanovaleric acid) and like azo polymerization initiators. Although the amounts of these radical polymerization initiators used are not particularly limited, they are generally preferably about 0.1 to about 15 parts by mass, and more preferably about 0.3 to about 10 parts by mass, per 100 parts by mass of the total mass of the monomers (a) and (b).

The method of adding the monomeric components and polymerization initiator in the above polymerization reaction is subject to no particular limitation, but from the viewpoints of easy temperature control during the polymerization reaction and suppression of occurrence of a poorly cross-linked product, such as a gelated product, it is preferable to add the polymerization initiator dropwise, as divided into plural portions over from the initial stage of polymerization to the late stage, rather than feeding it all at once in the initial stage of the polymerization.

An example of the method for preparing the resin (C) having an aromatic ring with a nitro group bonded thereto is as follows: a glycidyl-containing polymerizable unsaturated monomer and the other polymerizable unsaturated monomer(s) are copolymerized by the solution polymerization as mentioned above to obtain a copolymer, and the glycidyl groups in the copolymer and an aromatic carboxylic acid having a nitro group are then reacted in the presence of a tertiary amine and/or a quaternary ammonium salt at about 90 to about 160° C. for about 2 to about 10 hours.

To improve the water resistance of the coating film formed by using the aqueous coating composition of the present invention, the thus-obtained resin (C) having an aromatic ring with a nitro group bonded thereto preferably has a hydroxy value of about 5 to about 180 mg KOH/g, more preferably about 20 to about 140 mg KOH/g, and even more preferably about 40 to about 100 mg KOH/g. The acid value of the resin (C) is preferably about 0 to about 150 mg KOH/g, more preferably about 0 to about 120 mg KOH/g, and even more preferably about 0 to about 80 mg KOH/g.

The weight average molecular weight of the resin (C) is preferably about 3,000 to about 500,000, more preferably about 5,000 to 200,000, and even more preferably about 10,000 to about 100,000.

In this specification, the terms “number average molecular weight” and “weight average molecular weight” refer to the values obtained by converting the number average molecular weight and the weight molecular weight as determined by a gel permeation chromatograph, and expressed in terms of the molecular weight of standard polystyrene.

### Film-Forming Resin (D)

Water-soluble or water-dispersible film-forming resins known per se, that have been used as the binder component of aqueous coating compositions, can be used as the film-forming resin (D). Examples of the film-forming resin (D) include acrylic resin, polyester resin, alkyd resin, and polyurethane resin. The film-forming resin (D) preferably includes a functional group such as a hydroxy group, a carboxy group, an epoxy group, etc., and is preferably a hydroxy-containing resin.

In addition, the film-forming resin (D) does not include the resin (C) having an aromatic ring with a nitro group bonded thereto. More specifically, the film-forming resin (D) is a film-forming resin other than the resin (C) having an aromatic ring with a nitro group bonded thereto.

The aqueous coating composition of the present invention may further contain a curing agent (E) described later. When the aqueous coating composition of the present invention contains the curing agent (E), a resin (base resin) that has a functional group such as a hydroxy group, a carboxy group, an epoxy group, etc., and that can form a cured coating by reaction with the curing agent (E) is generally used as the film-forming resin (D). Examples of the base resin include acrylic resin, polyester resin, alkyd resin, and polyurethane resin. The base resin is preferably a hydroxy-containing resin, more preferably a hydroxy-containing acrylic resin (D1) and/or a hydroxy-containing polyester resin (D2). In terms of improving the smoothness and luster (flip-flop property) of the resulting coating film, it is preferable that the hydroxy-containing acrylic resin (D1) and the hydroxy-containing polyester resin (D2) be used together. In this case, the content of the hydroxy-containing acrylic resin (D1) is preferably about 20 to 80 mass %, particularly about 30 to 70 mass %; and the content of the hydroxy-containing polyester resin (D2) is preferably about 80 to 20 mass %, particularly about 70 to 30 mass %, based on the total amount of these resins.

When an acid group such as a carboxy group etc. is contained, the film-forming resin (D) has an acid value of preferably about 1 to 150 mg KOH/g, more preferably about 5 to 100 mg KOH/g, further preferably about 10 to 80 mg KOH/g.

When a hydroxy group is contained, the film-forming resin (D) has a hydroxy value of preferably about 1 to 200 mg KOH/g, more preferably about 2 to 180 mg KOH/g, further preferably about 5 to 170 mg KOH/g.

### Hydroxy-Containing Acrylic Resin (D1)

The hydroxy-containing acrylic resin (D1) can be produced by copolymerizing, for example, a hydroxy-containing polymerizable unsaturated monomer and other polymerizable unsaturated monomer(s) copolymerizable with the hydroxy-containing polymerizable unsaturated monomer; using methods known per se, such as a solution polymerization method in an organic solvent, an emulsion polymerization method in water, etc.

The hydroxy-containing polymerizable unsaturated monomer is a compound that includes one or more hydroxy groups, and one or more polymerizable unsaturated bonds per molecule. Examples of the hydroxy-containing polymerizable unsaturated monomer include: monoesterified products of (meth)acrylic acid with a dihydric alcohol having 2 to 8 carbon atoms (e.g., 2-hydroxyethyl(meth)acrylate, 2-hydroxypropyl(meth)acrylate, 3-hydroxypropyl(meth)acrylate, and 4-hydroxybutyl(meth)acrylate); ε-caprolactone modified products of the monoesterified products of (meth)acrylic acid with a dihydric alcohol having 2 to 8 carbon atoms; N-hydroxymethyl(meth)acrylamide; allyl alcohol; and (meth)acrylates that include hydroxy-terminated polyoxyethylene chains. These may be used singly, or in a combination of two or more.

The other polymerizable unsaturated monomers polymerizable with the hydroxy-containing polymerizable unsaturated monomer may be, for example, the polymerizable unsaturated monomers exemplified above as other polymerizable unsaturated monomers (b) in the description of the resin (C) having an aromatic ring with a nitro group bonded thereto, including the polymerizable unsaturated monomers (i) to (ix) and (xi) to (xx) other than the hydroxy-containing polymerizable unsaturated monomer. Such polymerizable unsaturated monomers may be used singly, or in a combination of two or more.

The hydroxy-containing acrylic resin (D1) preferably contains an amide group. The hydroxy-containing acrylic resin containing an amide group can be produced by using, for example, an amide-containing polymerizable unsaturated monomer, such as (meth)acrylamide, N,N-dimethylaminopropyl(meth)acrylamide, etc., as an example of the polymerizable unsaturated monomer polymerizable with the hydroxy-containing polymerizable unsaturated monomer.

The content of the hydroxy-containing polymerizable unsaturated monomer used to produce the hydroxy-containing acrylic resin (D1) is preferably about 1 to 50 mass %, more preferably about 2 to 40 mass %, further preferably about 3 to 30 mass %, based on the total amount of the monomer component.

The hydroxy-containing acrylic resin (D1) preferably has an acid value of about 1 to 150 mg KOH/g, more preferably about 5 to 100 mg KOH/g, and further preferably about 10 to 80 mg KOH/g in terms of properties such as the preservative stability of the coating composition and the water resistance of the resulting coating film.

The hydroxy-containing acrylic resin (D1) preferably has a hydroxy value of about 1 to 200 mg KOH/g, more preferably about 2 to 150 mg KOH/g, and further preferably about 5 to 100 mg KOH/g in terms of properties such as the water resistance of the resulting coating film.

The hydroxy-containing acrylic resin (D1) is preferably formed of a core-shell-type water-dispersible hydroxy-containing acrylic resin used alone or in combination with a water-soluble acrylic resin, in terms of improving the smoothness and luster of the resulting coating film.

In terms of improving the smoothness and luster of the resulting coating film, a preferable example of the core-shell-type water-dispersible hydroxy-containing acrylic resin is a core-shell-type water-dispersible hydroxy-containing acrylic resin (D1′) comprising: a core that is a copolymer (I) consisting of about 0.1 to 30 mass % of a polymerizable unsaturated monomer having two or more polymerizable unsaturated groups per molecule, and about 70 to 99.9 mass % of a polymerizable unsaturated monomer having one polymerizable unsaturated group per molecule; and a shell that is a copolymer (II) consisting of about 1 to 40 mass % of a hydroxy-containing polymerizable unsaturated monomer, about 5 to 50 mass % of a hydrophobic polymerizable unsaturated monomer, and about 10 to 94 mass % of other polymerizable unsaturated monomer(s).

Examples of polymerizable unsaturated monomers having two or more polymerizable unsaturated groups per molecule, and that can be used as a monomer for the core copolymer (I) include allyl(meth)acrylate, ethylene glycol di(meth)acrylate, triethylene glycol di(meth)acrylate, tetraethylene glycol di(meth)acrylate, 1,3-butylene glycol di(meth)acrylate, trimethylol propane tri(meth)acrylate, 1,4-butanediol di(meth)acrylate, neopentyl glycol di(meth)acrylate, 1,6-hexanediol di(meth)acrylate, pentaerythritol di(meth)acrylate, pentaerythritol tetra(meth)acrylate, glycerol di(meth)acrylate, 1,1,1-tris-hydroxymethylethane di(meth)acrylate, 1,1,1-tris-hydroxymethylethane tri(meth)acrylate, 1,1,1-tris-hydroxymethylpropane tri(meth)acrylate, triallyl isocyanurate, diallyl terephthalate, divinylbenzene, etc. Such monomers can be used singly, or in a combination of two or more.

The polymerizable unsaturated monomer having two or more polymerizable unsaturated groups per molecule functions to provide a crosslinked structure to the core copolymer (I). Although the amount of the polymerizable unsaturated monomer having two or more polymerizable unsaturated groups per molecule can be suitably selected according to the desired degree of crosslinking of the core copolymer (I), the amount of the polymerizable unsaturated monomer having two or more polymerizable unsaturated groups per molecule is preferably in a range of about 0.1 to 30 mass %, more preferably about 0.5 to 10 mass %, and even more preferably about 1 to 7 mass %, based on the total mass of the polymerizable unsaturated monomer having two or more polymerizable unsaturated groups per molecule and the polymerizable unsaturated monomer having one polymerizable unsaturated group per molecule.

To suppress metallic mottling of the resulting coating film, the polymerizable unsaturated monomer having two or more polymerizable unsaturated groups per molecule is preferably an amide-containing monomer, such as methylene bis(meth)acrylamide, ethylene bis(meth)acrylamide, etc. The amount of the amide-containing monomer, when used, is preferably about 0.1 to 25 mass %, more preferably about 0.5 to 8 mass %, and even more preferably about 1 to 4 mass %, based on the total mass of the polymerizable unsaturated monomer having two or more polymerizable unsaturated groups per molecule and the unsaturated monomer having one polymerizable unsaturated group per molecule.

The polymerizable unsaturated monomer having one polymerizable unsaturated group per molecule, which is used as a monomer for the core copolymer (I), is a polymerizable unsaturated monomer that can be copolymerized with a polymerizable unsaturated monomer having two or more polymerizable unsaturated groups per molecule.

Specific examples of the polymerizable unsaturated monomer having one polymerizable unsaturated group per molecule include alkyl or cycloalkyl(meth)acrylates such as methyl(meth)acrylate, ethyl(meth)acrylate, n-propyl(meth)acrylate, isopropyl(meth)acrylate, n-butyl(meth)acrylate, isobutyl(meth)acrylate, tert-butyl(meth)acrylate, n-hexyl(meth)acrylate, n-octyl(meth)acrylate, 2-ethylhexyl(meth)acrylate, nonyl(meth)acrylate, tridecyl(meth)acrylate, lauryl(meth)acrylate, stearyl(meth)acrylate, isostearyl(meth)acrylate, cyclohexyl(meth)acrylate, methylcyclohexyl(meth)acrylate, tert-butylcyclohexyl(meth)acrylate, cyclododecyl(meth)acrylate, and tricyclodecanyl(meth)acrylate; isobornyl-containing polymerizable unsaturated monomers such as isobornyl(meth)acrylate; adamantyl-containing polymerizable unsaturated monomers such as adamantyl(meth)acrylate; tricyclodecenyl-containing polymerizable unsaturated monomers such as tricyclodecenyl(meth)acrylate; aromatic ring-containing polymerizable unsaturated monomers such as benzyl(meth)acrylate, styrene, α-methylstyrene and vinyltoluene; alkoxysilyl-containing polymerizable unsaturated monomers such as vinyltrimethoxysilane, vinyltriethoxysilane, vinyltris(2-methoxyethoxy)silane, γ-(meth)acryloyloxypropyltrimethoxysilane and γ-(meth)acryloyloxypropyltriethoxysilane; perfluoroalkyl(meth)acrylates such as perfluorobutylethyl(meth)acrylate and perfluorooctylethyl(meth)acrylate; fluorinated alkyl-containing polymerizable unsaturated monomers such as fluoroolefins; polymerizable unsaturated monomers having photopolymerizable functional groups such as a maleimide group; vinyl compounds such as N-vinylpyrrolidone, ethylene, butadiene, chloroprene, vinyl propionate and vinyl acetate; hydroxy-containing polymerizable unsaturated monomers such as monoesterified products of (meth)acrylic acid with a dihydric alcohol containing 2 to 8 carbon atoms (such as 2-hydroxyethyl(meth)acrylate, 2-hydroxypropyl(meth)acrylate, 3-hydroxypropyl(meth)acrylate and 4-hydroxybutyl(meth)acrylate), ε-caprolactone-modified products of the monoesterified products of (meth)acrylic acid with a dihydric alcohol containing 2 to 8 carbon atoms, N-hydroxymethyl(meth)acrylamide, allyl alcohol, and (meth)acrylates having hydroxy-terminated polyoxyethylene chains; carboxy-containing polymerizable unsaturated monomers such as (meth)acrylic acid, maleic acid, crotonic acid and β-carboxyethyl acrylate; nitrogen-containing polymerizable unsaturated monomers such as (meth)acrylonitrile, (meth)acrylamide, N,N-dimethylaminoethyl(meth)acrylate, N,N-diethylaminoethyl(meth)acrylate, N,N-dimethylaminopropyl(meth)acrylamide and adducts of glycidyl(meth)acrylate with amine compounds; epoxy-containing polymerizable unsaturated monomers such as glycidyl(meth)acrylate, β-methylglycidyl(meth)acrylate, 3,4-epoxycyclohexylmethyl(meth)acrylate, 3,4-epoxycyclohexylethyl(meth)acrylate, 3,4-epoxycyclohexylpropyl(meth)acrylate and allyl glycidyl ether; and (meth)acrylates having alkoxy-terminated polyoxyethylene chains. These monomers can be used singly, or in a combination of two or more, depending on the performance required for the core-shell type water-dispersible hydroxyl-containing acrylic resin (D1′).

The hydroxy-containing polymerizable unsaturated monomer used as a monomer for the shell copolymer (II) introduces a hydroxy group that can crosslink with the curing agent (E) into a water-dispersible acrylic resin, and thereby functions to enhance the water resistance of the coating film and enhance the stability of the water-dispersible acrylic resin in an aqueous medium. Examples of hydroxy-containing polymerizable unsaturated monomers include monoesterified products of (meth)acrylic acid with a dihydric alcohol containing 2 to 8 carbon atoms, such as 2-hydroxyethyl(meth)acrylate, 2-hydroxypropyl(meth)acrylate, 3-hydroxypropyl(meth)acrylate, 4-hydroxybutyl(meth)acrylate, etc.; ε-caprolactone-modified products of the monoesterified products of (meth)acrylic acid with a dihydric alcohol containing 2 to 8 carbon atoms; N-hydroxymethyl(meth)acrylamide; allyl alcohol; (meth)acrylate having a polyoxyethylene chain with a terminal hydroxy group; etc. Such monomers can be used singly, or in a combination of two or more. Examples of monomers preferably used as the hydroxy-containing polymerizable unsaturated monomer include 2-hydroxyethyl(meth)acrylate, 2-hydroxypropyl(meth)acrylate, 3-hydroxypropyl(meth)acrylate, 4-hydroxybutyl(meth)acrylate, etc.

To provide a core-shell-type water-dispersible hydroxy-containing polymerizable unsaturated acrylic resin (D1′) with excellent stability in an aqueous medium and provide the coating film with excellent water resistance, the amount of hydroxy-containing polymerizable unsaturated monomer is preferably about 1 to 40 mass %, more preferably about 4 to 25 mass %, and even more preferably about 7 to 19 mass %, based on the total mass of the monomers constituting the shell copolymer (II).

The hydrophobic polymerizable unsaturated monomer used as a monomer for the shell copolymer (II) is a polymerizable unsaturated monomer containing a linear, branched or cyclic saturated or unsaturated hydrocarbon group containing 6 or more, more preferably 6 to 18 carbon atoms, excluding monomers containing a hydrophilic group, such as hydroxy-containing polymerizable unsaturated monomers. Examples of hydrophobic polymerizable unsaturated monomers include alkyl or cycloalkyl(meth)acrylates, such as n-hexyl(meth)acrylate, octyl(meth)acrylate, 2-ethylhexyl(meth)acrylate, nonyl(meth)acrylate, tridecyl(meth)acrylate, lauryl(meth)acrylate, stearyl(meth)acrylate, isostearyl(meth)acrylate, cyclohexyl(meth)acrylate, methylcyclohexyl(meth)acrylate, tert-butylcyclohexyl(meth)acrylate, cyclododecyl(meth)acrylate, tricyclodecanyl(meth)acrylate, etc.; isobornyl-containing polymerizable unsaturated compounds, such as isobornyl(meth)acrylate, etc.; adamantyl-containing polymerizable unsaturated compounds, such as adamantyl(meth)acrylate, etc.; and aromatic ring-containing polymerizable unsaturated monomers such as benzyl(meth)acrylate, styrene, α-methylstyrene, vinyltoluene, etc. Such monomers can be used singly, or in a combination of two or more.

To enhance the smoothness and luster of the resulting coating film, the hydrophobic polymerizable unsaturated monomer is preferably a polymerizable unsaturated monomer having an alkyl group containing 6 to 18 carbon atoms and/or a polymerizable unsaturated monomer having an aromatic ring. Styrene is particularly preferable.

To provide a core-shell-type water-dispersible hydroxy-containing acrylic resin (D1′) with excellent stability in an aqueous medium and provide the coating film with excellent water resistance, the amount of hydrophobic polymerizable unsaturated monomer is preferably about 5 to 50 mass %, more preferably about 7 to 40 mass %, and even more preferably about 9 to 30 mass %, based on the total mass of the monomers constituting the shell copolymer (II).

The other polymerizable unsaturated monomer(s) used as a monomer for the shell copolymer (II) are polymerizable unsaturated monomers other than hydroxy-containing polymerizable unsaturated monomers and hydrophobic polymerizable unsaturated monomers. Examples of such monomers include alkyl or cycloalkyl(meth)acrylates, such as methyl(meth)acrylate, ethyl(meth)acrylate, n-propyl(meth)acrylate, iso-propyl(meth)acrylate, n-butyl(meth)acrylate, iso-butyl(meth)acrylate, tert-butyl(meth)acrylate, etc.; and carboxy-containing polymerizable unsaturated monomers, etc. Such monomers can be used singly, or in a combination of two or more.

Specific examples of carboxy-containing polymerizable unsaturated monomers are the same as mentioned above as examples of a monomer for the core copolymer (I). Acrylic acid and/or methacrylic acid are particularly preferable as a carboxy-containing polymerizable unsaturated monomer. By using a carboxy-containing polymerizable unsaturated monomer as other polymerizable unsaturated monomer(s), the resulting core-shell-type water-dispersible hydroxy-containing acrylic resin (D1′) becomes stable in an aqueous medium.

To provide a core-shell-type water-dispersible hydroxy-containing acrylic resin (D1′) with excellent stability in an aqueous medium and provide the coating film with excellent water resistance, the amount of carboxy-containing polymerizable unsaturated monomer is preferably about 1 to 30 mass %, more preferably about 5 to 25 mass %, and even more preferably about 7 to 19 mass %, based on the total mass of the monomers constituting the shell copolymer (II).

To enhance the luster of the resulting coating film, it is preferable not to use polymerizable unsaturated monomers having two or more polymerizable unsaturated groups per molecule as the other polymerizable unsaturated monomers for constituting the shell copolymer (II), thus forming an uncrosslinked copolymer (II).

To enhance the appearance of the resulting coating film, the ratio of the copolymer (I) to the copolymer (II) in the core-shell-type water-dispersible hydroxy-containing acrylic resin (D1′) is preferably in the range of about 10/90 to 90/10, more preferably about 50/50 to 85/15, and particularly preferably about 65/35 to 80/20, on a solids basis.

To provide the coating film with excellent water resistance, etc., the core-shell-type water-dispersible hydroxy-containing acrylic resin (D1′) preferably has a hydroxy value of about 1 to 70 mg KOH/g, more preferably about 2 to 50 mg KOH/g, and even more preferably about 5 to 30 mg KOH/g.

To provide the coating composition with excellent storage stability and provide the coating film with excellent water resistance etc., the core-shell-type water-dispersible hydroxy-containing acrylic resin (D1′) preferably has an acid value of about 5 to about 90 mg KOH/g, more preferably about 8 to about 50 mg KOH/g, and even more preferably about 10 to about 35 mg KOH/g.

The core-shell-type water-dispersible hydroxy-containing acrylic resin (D1′) can be prepared by a process comprising: subjecting to emulsion polymerization a monomer mixture of about 0.1 to 30 mass % of a polymerizable unsaturated monomer having two or more polymerizable unsaturated groups per molecule, and about 70 to 99.9 mass % of a polymerizable unsaturated monomer having one polymerizable unsaturated group per molecule to form an emulsion of a core copolymer (I); adding to this emulsion a monomer mixture of about 1 to 40 mass % of a hydroxy-containing polymerizable unsaturated monomer, about 5 to 50 mass % of a hydrophobic polymerizable unsaturated monomer, and about 10 to 94 mass % of other polymerizable unsaturated monomer(s), and further performing emulsion polymerization to form a shell copolymer (II).

The emulsion polymerization for preparing an emulsion of the core copolymer (I) can be carried out according to known methods. For example, the emulsion can be prepared by subjecting the monomer mixture to emulsion polymerization using a polymerization initiator in the presence of an emulsifier.

For the above emulsifier, anionic emulsifiers and nonionic emulsifiers are suitable. Examples of anionic emulsifiers include sodium salts and ammonium salts of alkylsulfonic acids, alkylbenzenesulfonic acids, alkylphosphoric acids, etc. Examples of nonionic emulsifiers include polyoxyethylene oleyl ether, polyoxyethylene stearyl ether, polyoxyethylene lauryl ether, polyoxyethylene tridecyl ether, polyoxyethylene phenyl ether, polyoxyethylene nonylphenyl ether, polyoxyethylene octylphenyl ether, polyoxyethylene monolaurate, polyoxyethylene monostearate, polyoxyethylene monooleate, sorbitan monolaurate, sorbitan monostearate, sorbitan trioleate, polyoxyethylene sorbitan monolaurate, etc.

Other examples of usable emulsifiers include polyoxyalkylene-containing anionic emulsifiers that have an anionic group, and a polyoxyalkylene group, such as a polyoxyethylene group, polyoxypropylene group, per molecule; and reactive anionic emulsifiers that have an anionic group and a radically polymerizable unsaturated group per molecule. Among these, reactive anionic emulsifiers are preferable.

Examples of reactive anionic emulsifiers include sodium salts of sulfonic acid compounds having a radically polymerizable unsaturated group, such as allyl, methallyl, (meth)acryloyl, propenyl, butenyl or the like; ammonium salts of such sulfonic acid compounds, etc. Among these, ammonium salts of sulfonic acid compounds having a radically polymerizable unsaturated group are preferable in view of the excellent water resistance of the resulting coating film. Examples of commercially available ammonium salts of such sulfonic acid compounds include “LATEMUL S-180A” (tradename of Kao Corporation).

Among the ammonium salts of sulfonic acid compounds having a radically polymerizable unsaturated group, ammonium salts of sulfonic acid compounds having a radically polymerizable unsaturated group and a polyoxyalkylene group are particularly preferable. Commercially available ammonium salts of sulfonic acid compounds having a radically polymerizable unsaturated group and a polyoxyalkylene group include “Aqualon KH-10” (tradename, Dai-Ichi Kogyo Seiyaku Co., Ltd.), “LATEMUL PD-104” (tradename, Kao Corporation), “Adekaria Soap SR-1025” (tradename of ADEKA Co., Ltd.) etc.

The amount of emulsifier is preferably about 0.1 to 15 mass %, more preferably about 0.5 to 10 mass %, and even more preferably about 1 to 5 mass %, based on the total mass of the monomers used.

Examples of polymerization initiators include organic peroxides such as benzoyl peroxide, octanoyl peroxide, lauroyl peroxide, stearoyl peroxide, cumene hydroperoxide, tert-butyl peroxide, tert-butyl peroxylaurate, tert-butyl peroxyisopropylcarbonate, tert-butyl peroxyacetate, diisopropylbenzene hydroperoxide, etc.; azo compounds such as azobisisobutyronitrile, azobis(2,4-dimethylvaleronitrile), azobis(2-methylpropionenitrile), azobis(2-methylbutyronitrile), 4,4′-azobis(4-cyanobutanoic acid), dimethyl azobis(2-methyl propionate), azobis[2-methyl-N-(2-hydroxyethyl)-propionamide], azobis[2-methyl-N-[2-(1-hydroxy butyl)]-propionamide], etc.; persulfates such as potassium persulfate, ammonium persulfate, sodium persulfate, etc.; etc. Such polymerization initiators can be used singly, or in a combination of two or more. Redox initiators prepared by combining a polymerization initiator as mentioned above with a reducing agent such as sugar, sodium formaldehyde sulfoxylate, iron complex, etc. may also be used.

The amount of polymerization initiator is generally preferably about 0.1 to 5 mass %, and more preferably about 0.2 to 3 mass %, based on the total mass of all of the monomers used. The method of adding the polymerization initiator is not particularly limited, and can be suitably selected according to the kind and amount of polymerization initiator used. For example, the polymerization initiator may be incorporated into a monomer mixture or an aqueous medium beforehand, or may be added dropwise or all at once at the time of polymerization.

The core-shell-type water-dispersible hydroxy-containing acrylic resin (D1′) can be obtained by adding to the above-obtained emulsion of the core copolymer (I) a monomer mixture of a hydroxy-containing polymerizable unsaturated monomer, a hydrophobic polymerizable unsaturated monomer, and other polymerizable unsaturated monomer(s), and further performing polymerization to form a shell copolymer (II).

The monomer mixture for forming the shell copolymer (II) may optionally contain other components such as polymerization initiators as mentioned above, chain transfer agents, reducing agents, and emulsifiers, etc. The monomer mixture is preferably added dropwise as a monomer emulsion obtained by dispersing the monomer mixture into an aqueous medium, although it may be added dropwise as is. In this case, the particle size of the monomer emulsion is not particularly limited.

The method for polymerizing the monomer mixture for forming the shell copolymer (II) comprises, for example, adding the monomer mixture or emulsion thereof dropwise to the emulsion of the core copolymer (I) all at once or gradually, and heating to a suitable temperature while stirring.

The core-shell-type water-dispersible hydroxy-containing acrylic resin (D1′) thus obtained has a multiple-layer structure comprising a core copolymer (I) of a monomer mixture of a polymerizable unsaturated monomer having two or more polymerizable unsaturated groups per molecule and a polymerizable unsaturated monomer having one polymerizable unsaturated group per molecule, and a shell copolymer (II) of a monomer mixture of a hydroxy-containing polymerizable unsaturated monomer, a hydrophobic polymerizable unsaturated monomer, and other polymerizable unsaturated monomer(s).

The core-shell-type water-dispersible hydroxy-containing acrylic resin (D1′) thus obtained usually has a mean particle size of about 10 to 1,000 nm, and particularly about 20 to 500 nm.

In this specification, the mean particle size of the core-shell-type water-dispersible hydroxy-containing acrylic resin (D1′) refers to a value obtained by measurement at 20° C. using a submicron particle size distribution analyzer after dilution with deionized water according to a usual method. For example, a “COULTER N4” (tradename, Beckman Coulter, Inc.) can be used as the submicron particle size distribution analyzer.

To improve the mechanical stability of the particles of the core-shell-type water-dispersible hydroxy-containing acrylic resin (D1′), acid groups such as carboxy groups of the water-dispersible acrylic resin are preferably neutralized with a neutralizing agent. The neutralizing agent is not particularly limited, as long as it can neutralize acid groups. Examples of such neutralizing agents include sodium hydroxide, potassium hydroxide, trimethylamine, 2-(dimethylamino)ethanol, 2-amino-2-methyl-1-propanol, triethylamine, aqueous ammonia, etc. Such a neutralizing agent is preferably used in an amount such that the pH of the aqueous dispersion of the water-dispersible acrylic resin after neutralization is about 6.5 to about 9.0.

### Hydroxy-Containing Polyester Resin (D2)

In the aqueous coating composition of the present invention, use of the hydroxy-containing polyester resin (D2) as the film-forming resin (D) improves smoothness and the like of the resulting coating film.

The hydroxy-containing polyester resin (D2) can usually be produced by an esterification reaction or transesterification reaction of an acid component with an alcohol component.

The acid component may be a compound that is conventionally used as an acid component for producing a polyester resin. Examples of such acid components include aliphatic polybasic acids, alicyclic polybasic acids, aromatic polybasic acids, etc.

Generally, aliphatic polybasic acids include aliphatic compounds having at least two carboxy groups per molecule; anhydrides of such aliphatic compounds; and esters of such aliphatic compounds. Examples of aliphatic polybasic acids include succinic acid, glutaric acid, adipic acid, pimelic acid, suberic acid, azelaic acid, sebacic acid, undecanedioic acid, dodecanedioic acid, brassylic acid, octadecanedioic acid, citric acid, and like aliphatic polycarboxylic acids; anhydrides of such aliphatic polycarboxylic acids; esters of such aliphatic polycarboxylic acids with about C1-C4 lower alkyls; etc. Such aliphatic polybasic acids can be used singly, or in a combination of two or more.

In terms of the smoothness etc. of the resulting coating film, it is particularly preferable to use adipic acid and/or adipic anhydride as an aliphatic polybasic acid.

Generally, alicyclic polybasic acids include compounds having at least one alicyclic structure and at least two carboxy groups per molecule; acid anhydrides of such compounds; and esters of such compounds. The alicyclic structure is typically a 4-6 membered ring structure. Examples of alicyclic polybasic acids include 1,2-cyclohexanedicarboxylic acid, 1,3-cyclohexanedicarboxylic acid, 1,4-cyclohexanedicarboxylic acid, 4-cyclohexene-1,2-dicarboxylic acid, 3-methyl-1,2-cyclohexanedicarboxylic acid, 4-methyl-1,2-cyclohexanedicarboxylic acid, 1,2,4-cyclohexanetricarboxylic acid, 1,3,5-cyclohexanetricarboxylic acid, and like alicyclic polycarboxylic acids; anhydrides of such alicyclic polycarboxylic acids; esters of such alicyclic polycarboxylic acids with about C1-C4 lower alkyls; etc. Such alicyclic polybasic acids can be used singly, or in a combination of two or more.

In terms of the smoothness of the resulting coating film, preferable alicyclic polybasic acids include 1,2-cyclohexanedicarboxylic acid, 1,2-cyclohexanedicarboxylic anhydride, 1,3-cyclohexanedicarboxylic acid, 1,4-cyclohexanedicarboxylic acid, 4-cyclohexene-1,2-dicarboxylic acid, and 4-cyclohexene-1,2-dicarboxylic anhydride. Among these, it is particularly preferable to use 1,2-cyclohexanedicarboxylic acid and/or 1,2-cyclohexanedicarboxylic anhydride.

Generally, aromatic polybasic acids include aromatic compounds having at least two carboxy groups per molecule; anhydrides of such aromatic compounds; and esters of such aromatic compounds. Examples of aromatic polybasic acids include phthalic acid, isophthalic acid, terephthalic acid, naphthalenedicarboxylic acid, 4,4′-biphenyldicarboxylic acid, trimellitic acid, pyromellitic acid, and like aromatic polycarboxylic acids; anhydrides of such aromatic polycarboxylic acids; esters of such aromatic polycarboxylic acids with about C1 to about C4 lower alkyls; etc. Such aromatic polybasic acids can be used singly, or in a combination of two or more.

Preferable aromatic polybasic acids include phthalic acid, phthalic anhydride, isophthalic acid, trimellitic acid, and trimellitic anhydride.

Acid components other than aliphatic polybasic acids, alicyclic polybasic acids, and aromatic polybasic acids can also be used. Such other acid components are not limited, and include, for example, coconut oil fatty acid, cottonseed oil fatty acid, hempseed oil fatty acid, rice bran oil fatty acid, fish oil fatty acid, tall oil fatty acid, soybean oil fatty acid, linseed oil fatty acid, tung oil fatty acid, rapeseed oil fatty acid, castor oil fatty acid, dehydrated castor oil fatty acid, safflower oil fatty acid, and like fatty acids; lauric acid, myristic acid, palmitic acid, stearic acid, oleic acid, linolic acid, linolenic acid, benzoic acid, p-tert-butyl benzoic acid, cyclohexanoic acid, 10-phenyloctadecanoic acid, and like monocarboxylic acids; and lactic acid, 3-hydroxybutanoic acid, 3-hydroxy-4-ethoxybenzoic acid, and like hydroxycarboxylic acids. Such acid components can be used singly, or in a combination of two or more.

Polyhydric alcohols having at least two hydroxy groups per molecule can be preferably used as the above-mentioned alcohol component. Examples of such polyhydric alcohols include ethylene glycol, propylene glycol, diethylene glycol, trimethylene glycol, tetraethylene glycol, triethylene glycol, dipropylene glycol, 1,4-butanediol, 1,3-butanediol, 2,3-butanediol, 1,2-butanediol, 3-methyl-1,2-butanediol, 2-butyl-2-ethyl-1,3-propanediol, 1,2-pentanediol, 1,5-pentanediol, 1,4-pentanediol, 2,4-pentanediol, 2,3-dimethyltrimethylene glycol, tetramethylene glycol, 3-methyl-4,3-pentanediol, 3-methyl-1,5-pentanediol, 2,2,4-trimethyl-1,3-pentanediol, 1,6-hexanediol, 1,5-hexanediol, 1,4-hexanediol, 2,5-hexanediol, neopentyl glycol, 1,4-cyclohexanedimethanol, tricyclodecanedimethanol, hydrogenated bisphenol A, hydrogenated bisphenol F, and like dihydric alcohols; polylactone diols obtained by adding lactone compounds, such as ε-caprolactone, to such dihydric alcohols; bis(hydroxyethyl)terephthalate and like ester diol compounds; alkylene oxide adducts of bisphenol A, polyethylene glycols, polypropylene glycols, polybutylene glycols, and like polyether diol compounds; glycerol, trimethylolethane, trimethylolpropane, diglycerol, triglycerol, 1,2,6-hexanetriol, pentaerythritol, dipentaerythritol, tris(2-hydroxyethyl)isocyanuric acid, sorbitol, mannitol, and like trihydric or higher polyhydric alcohols; polylactone polyol compounds obtained by adding lactone compounds, such as ε-caprolactone, to such trihydric or higher polyhydric alcohols, etc.

Alcohol components other than polyhydric alcohols can also be used. Such other alcohol components are not limited, and include, for example, methanol, ethanol, propyl alcohol, butyl alcohol, stearyl alcohol, 2-phenoxyethanol, and like monohydric alcohols; alcohol compounds obtained by reacting, with acids, propylene oxide, butylene oxide, “Cardura E10” (tradename of HEXION Specialty Chemicals; glycidyl ester of a synthetic highly branched saturated fatty acid), and like monoepoxy compounds; etc.

The production method for the hydroxy-containing polyester resin (D2) is not limited, and may be performed by any usual method. For example, the hydroxy-containing polyester resin can be produced by heating the acid component and alcohol component in a nitrogen stream at about 150 to about 250° C. for about 5 to 10 hours to thereby carry out an esterification reaction or transesterification reaction of the acid component with the alcohol component.

For the esterification reaction or transesterification reaction, the acid component and alcohol component may be added to a reaction vessel at one time, or one or both of the components may be added in several portions. Alternatively, a hydroxy-containing polyester resin may be first synthesized and then reacted with an acid anhydride for half-esterification to thereby obtain a carboxy- and hydroxy-containing polyester resin. Further alternatively, a carboxy-containing polyester resin may be first synthesized, and the above-mentioned alcohol component may be added to obtain a hydroxy-containing polyester resin.

For promoting the esterification or transesterification reaction, known catalysts are usable, including, for example, dibutyltin oxide, antimony trioxide, zinc acetate, manganese acetate, cobalt acetate, calcium acetate, lead acetate, tetrabutyl titanate, tetraisopropyl titanate, etc.

The hydroxy-containing polyester resin (D2) can be modified with a fatty acid, monoepoxy compound, polyisocyanate compound, or the like, during or after the preparation of the resin.

Examples of the fatty acid include coconut oil fatty acid, cottonseed oil fatty acid, hempseed oil fatty acid, rice bran oil fatty acid, fish oil fatty acid, tall oil fatty acid, soybean oil fatty acid, flaxseed oil fatty acid, tung oil fatty acid, rapeseed oil fatty acid, castor oil fatty acid, dehydrated castor oil fatty acid, safflower oil fatty acid, etc. Preferable examples of the monoepoxy compound include “Cardura E10” (tradename of HEXION Specialty Chemicals; glycidyl ester of a synthetic highly branched saturated fatty acid).

Examples of the polyisocyanate compound include lysine diisocyanate, hexamethylene diisocyanate, trimethylhexane diisocyanate, and like aliphatic diisocyanate compounds; hydrogenated xylylene diisocyanate, isophorone diisocyanate, methylcyclohexane-2,4-diisocyanate, methylcyclohexane-2,6-diisocyanate, 4,4′-methylene bis(cyclohexylisocyanate), 1,3-(isocyanatomethyl)cyclohexane, and like alicyclic diisocyanate compounds; tolylene diisocyanate, xylylene diisocyanate, diphenylmethane diisocyanate, and like aromatic diisocyanate compounds; organic polyisocyanates, such as lysine triisocyanate and like tri- or higher polyisocyanates; adducts of such organic polyisocyanates with polyhydric alcohols, low-molecular-weight polyester resins, water, and/or the like; cyclopolymers (e.g., isocyanurate), biuret adducts, etc., of such organic polyisocyanates; etc. Such polyisocyanate compounds can be used singly, or in a combination of two or more.

In the hydroxy-containing polyester resin (D2), to obtain a coating film with excellent smoothness and excellent water resistance, the proportion of alicyclic polybasic acid in the acid components used as starting materials is, based on the total amount of the acid components, preferably about 20 to 100 mol %, more preferably about 25 to 95 mol %, and even more preferably about 30 to 90 mol %. In particular, it is preferable to use, as an alicyclic polybasic acid, 1,2-cyclohexanedicarboxylic acid and/or 1,2-cyclohexanedicarboxylic anhydride, in terms of providing a coating film with excellent smoothness of the resulting coating film.

The hydroxy-containing polyester resin (D2) preferably has a hydroxy value of about 1 to 200 mg KOH/g, more preferably about 2 to 180 mg KOH/g, and even more preferably about 5 to 170 mg KOH/g. When the hydroxy-containing polyester resin (D2) also has a carboxy group, the acid value of the resin is preferably about 5 to 150 mg KOH/g, more preferably about 10 to 100 mg KOH/g, and even more preferably about 15 to 80 mg KOH/g. The hydroxy-containing polyester resin (D2) preferably has a number average molecular weight of about 500 to about 50,000, more preferably about 1,000 to about 30,000, and even more preferably about 1,200 to about 10,000.

### Curing Agent (E)

The curing agent (E) is a compound that reacts with functional groups, such as hydroxy groups, carboxy groups, epoxy groups, etc., in the aqueous film-forming resin (D), to thereby cure the aqueous coating composition of the present invention. Examples of the curing agent (E) include amino resins, polyisocyanate compounds, blocked polyisocyanate compounds, epoxy-containing compounds, carboxy-containing compounds, carbodiimide group-containing compounds, etc. Among these, amino resins and blocked polyisocyanate compounds, which react with hydroxy groups, and carbodiimide group-containing compounds, which react with carboxy groups, are preferable. Amino resins are particularly preferable. Such compounds can be used singly, or in a combination of two or more as the curing agent (E).

Usable amino resins include partially or fully methylolated amino resins obtained by the reactions of amino components with aldehyde components. Examples of the amino components include melamine, urea, benzoguanamine, acetoguanamine, steroguanamine, spiroguanamine, dicyandiamide, etc. Examples of aldehyde components include formaldehyde, paraformaldehyde, acetaldehyde, benzaldehyde, etc.

Methylolated amino resins in which some or all of the methylol groups have been etherified with suitable alcohols are also usable. Alcohols that can be used for the etherification include, for example, methyl alcohol, ethyl alcohol, n-propyl alcohol, isopropyl alcohol, n-butyl alcohol, isobutyl alcohol, 2-ethylbutanol, 2-ethylhexanol, etc.

Preferable amino resins include melamine resins. Particularly preferable amino resins include methyl-etherified melamine resins obtained by etherifying some or all of the methylol groups of partially or fully methylolated melamine resins with methyl alcohol; butyl-etherified melamine resins obtained by etherifying some or all of the methylol groups of partially or fully methylolated melamine resins with butyl alcohol; and methyl-butyl-etherified melamine resins obtained by etherifying some or all of the methylol groups of partially or fully methylolated melamine resins with methyl alcohol and butyl alcohol. Among these, methyl-butyl-etherified melamine resins are particularly preferable.

These melamine resins preferably have a weight average molecular weight of about 400 to about 6,000, more preferably about 800 to about 5,000, even more preferably about 1,000 to about 4,000, and most preferably about 1,200 to about 3,000.

Commercially available melamine resins can be used as the melamine resin. Examples include commercially available products such as “Cymel 202”, “Cymel 203”, “Cymel 238”, “Cymel 251”, “Cymel 303”, “Cymel 323”, “Cymel 324”, “Cymel 325”, “Cymel 327”, “Cymel 350”, “Cymel 385”, “Cymel 1156”, “Cymel 1158”, “Cymel 1116”, “Cymel 1130” (products of Nihon Cytec Industries Inc.), “U-VAN 120”, “U-VAN 20HS”, “U-VAN 20SE60”, “U-VAN 2021”, “U-VAN 2028”, “U-VAN 28-60” (products of Mitsui Chemicals, Inc.), etc.

In the aqueous coating composition of the present invention, it is preferable to use the hydroxy-containing acrylic resin (D1), such as a core-shell-type water-dispersible hydroxy-containing acrylic resin (D1′), as the film-forming resin (D); and to use a melamine resin with a weight average molecular weight of about 1,000 to about 4,000, and more preferably about 1,200 to about 3,000, as the curing agent (E), to obtain a coating film with excellent luster (flip-flop property) and excellent water resistance.

When a melamine resin is used as the curing agent (E), paratoluene sulfonic acid, dodecylbenzenesulfonic acid, dinonylnaphthalene sulfonic acid, or like sulfonic acid; monobutyl phosphate, dibutyl phosphate, mono-2-ethylhexyl phosphate, di-2-ethylhexyl phosphate or the like alkyl phosphoric esters, or a salt of these acids with an amine compound, can be used as a catalyst.

The blocked polyisocyanate compounds are compounds obtained by blocking, with blocking agents, isocyanate groups of polyisocyanate compounds having at least two isocyanate groups per molecule. Examples of blocking agents include oxime compounds, phenolic compounds, alcoholic compounds, lactam compounds, and mercaptan compounds.

Examples of polyisocyanate compounds having at least two isocyanate groups per molecule include hexamethylene diisocyanate, trimethylhexamethylene diisocyanate, dimer acid diisocyanate, lysine diisocyanate, and like aliphatic diisocyanate compounds; hydrogenated xylylene diisocyanate, cyclohexylene diisocyanate, isophorone diisocyanate, and like alicyclic diisocyanate compounds; tolylene diisocyanate, phenylene diisocyanate, 4,4′-diphenylmethane diisocyanate, xylylene diisocyanate, tetramethylxylylene diisocyanate, naphthalene diisocyanate, and like aromatic diisocyanate compounds; trivalent or higher organic polyisocyanate compounds such as 2-isocyanatoethyl-2,6-diisocyanatocaproate, 3-isocyanatomethyl-1,6-hexamethylene diisocyanate, 4-isocyanatomethyl-1,8-octamethylene diisocyanate (commonly referred to as triamino-nonane triisocyanate); dimers and trimers of such polyisocyanate compounds; prepolymers obtained by urethanization reactions of such polyisocyanate compounds with polyhydric alcohols, low-molecular-weight polyester resins, or water, under conditions such that isocyanate groups are present in excess, etc.

Examples of carbodiimide group-containing compounds include, for example, those obtained by the decarbonation reactions between isocyanate groups of the above-mentioned polyisocyanate compounds. It is preferable to use, as the carbodiimide group-containing compound, a polycarbodiimide compound containing at least two carbodiimide groups per molecule.

The above-mentioned carbodiimide compounds are preferably water-soluble or water-dispersible polycarbodiimide compounds, in terms of the smoothness etc. of the resulting coating films. There is no particular limitation to the water-soluble or water-dispersible polycarbodiimide compounds, so long as the polycarbodiimide compounds are stably dissolved or dispersed in an aqueous medium.

Examples of the water-soluble polycarbodiimide compounds include “Carbodilite SV-02”, “Carbodilite V-02”, “Carbodilite V-02-L2”, “Carbodilite V-04” (manufactured by Nisshinbo Industries, Inc., trade names), and the like. Examples of the water-dispersible polycarbodiimide compounds include “Carbodilite E-01”, “Carbodilite E-02” (manufactured by Nisshinbo Industries, Inc., trade names), and the like.

Such carbodiimide compounds can be used singly, or in a combination of two or more.

It is preferable that the proportions of the aqueous film-forming resin (D) and the curing agent (E) in the aqueous metallic coating composition of the present invention be, based on the total amount of these components, about 30 to 95 mass %, preferably about 50 to 90 mass %, and more preferably about 60 to 80 mass % for the former; and about 5 to 70 mass %, preferably about 10 to 50 mass %, and more preferably about 20 to 40 mass % for the latter, to improve the smoothness, and water resistance of the resulting coating film.

When the aqueous coating composition of the present invention comprises the hydroxy-containing acrylic resin (D1), the proportion of the hydroxy-containing acrylic resin (D1) is, based on the solids content of the aqueous coating composition, preferably about 2 to 70 mass %, more preferably about 10 to 55 mass %, and even more preferably about 20 to 45 mass %.

When the aqueous coating composition of the present invention comprises the hydroxy-containing polyester resin (D2), the proportion of the hydroxy-containing polyester resin (D2) is, based on the solids content of the aqueous coating composition, preferably about 2 to 70 mass %, more preferably about 10 to 55 mass %, and even more preferably about 20 to 45 mass %.

### Aqueous Coating Composition

The aqueous coating composition of the present invention can be prepared by, for example, mixing the aluminium pigment (A) treated with molybdic acid, the condensed polycyclic pigment (B), the resin (C) having an aromatic ring with a nitro group bonded thereto, and the film-forming resin (D) in an aqueous medium; and dissolving or dispersing them in the medium using a known method.

Examples of the method for mixing the above components include a method of previously preparing a pigment dispersion of the aluminium pigment (A) treated with molybdic acid and a pigment dispersion of the condensed polycyclic pigment (B), and mixing and dispersing these pigment dispersions in an aqueous medium together with the resin (C) having an aromatic ring with a nitro group bonded thereto, the film-forming resin (D) etc.; a method of previously preparing a pigment dispersion by mixing the aluminium pigment (A) treated with molybdic acid and the resin (C) having an aromatic ring with a nitro group bonded thereto, and mixing and dispersing the pigment dispersion in an aqueous medium together with the condensed polycyclic pigment (B), the film-forming resin (D) etc.; and a method of previously preparing a pigment dispersion by mixing the condensed polycyclic pigment (B) and the resin (C) having an aromatic ring with a nitro group bonded thereto, and mixing and dispersing the pigment dispersion in an aqueous medium together with the aluminium pigment (A) treated with molybdic acid, the film-forming resin (D) etc.

Examples of usable aqueous media include water and organic-solvent-mixed solutions obtained by dissolving hydrophilic organic solvents in water. Examples of usable hydrophilic organic solvents include methyl alcohol, ethyl alcohol, isopropyl alcohol, propylene glycol monopropyl ether, ethylene glycol monobutyl ether, propylene glycol mono methyl ether, propylene glycol monobutyl ether, dipropylene glycol monomethyl ether, dipropylene glycol monobutyl ether, tripropylene glycol monomethyl ether, 3-methyl-3-methoxybutanol, etc. Such media can be used singly, or in a combination of two or more. The proportion of the water and the organic solvent in the water and organic-solvent-mixed solution is not particularly limited. However, the preferable amount of organic solvent is 1 to 50 mass %, more preferably 5 to 35 mass %.

In the aqueous coating composition of the present invention, the proportions of the aluminium pigment (A) treated with molybdic acid, the condensed polycyclic pigment (B), the resin (C) having an aromatic ring with a nitro group bonded thereto and the film-forming resin (D) are not particularly limited. However, the proportions preferably fall within the following ranges based on 100 parts by mass of the film-forming resin (D), in terms of the storage stability of the aqueous coating composition; and the appearance (smoothness, distinctness of image (hereinafter referred to as DOI), luster etc.), film performance (water resistance etc.) etc. of the resulting coating film.

The aluminium pigment (A) treated with molybdic acid: about 0.1 to 80 parts by mass, preferably about 0.5 to 40 parts by mass, further preferably about 1 to 20 parts by mass.

The condensed polycyclic pigment (B): about 0.01 to 40 parts by mass, preferably about 0.05 to 20 parts by mass, further preferably about 0.1 to 15 parts by mass.

The resin (C) having an aromatic ring with a nitro group bonded thereto: about 0.1 to 30 parts by mass, preferably about 0.2 to 20 parts by mass, further preferably about 0.3 to 10 parts by mass (when the phthalocyanine pigment (B1) is used as the condensed polycyclic pigment (B)); about 0.1 to 30 parts by mass, preferably about 0.5 to 15 parts by mass, further preferably about 1 to 10 parts by mass (when the condensed polycyclic pigment (B2) having two or more ketone structures per molecule is used as the condensed polycyclic pigment (B)).

The reason for the excellent storage stability of the aqueous coating composition of the present invention is not clearly understood; however, it may be assumed as follows. The existing aqueous coating compositions have a problem of color change during storage because some kind of change occurs in the chemical structure of the condensed polycyclic pigment (B) during storage due to the presence of the aluminium pigment (A) treated with molybdic acid. In contrast, in the aqueous coating composition of the present invention, the resin (C) having an aromatic ring with a nitro group bonded thereto serves to suppress the interaction between the aluminium pigment (A) treated with molybdic acid and the condensed polycyclic pigment (B), thereby preventing easy change in the chemical structure of the condensed polycyclic pigment (B).

In terms of improving the flip-flop property and DOI of the resulting coating film, the aqueous coating composition of the present invention preferably further contains a phthalocyanine pigment derivative (F).

Particularly, when the phthalocyanine pigment (B1) is contained as one kinds of the condensed polycyclic pigment (B), the aqueous coating composition of the present invention preferably contains the phthalocyanine pigment derivative (F).

Examples of the phthalocyanine pigment derivative (F) include a compound obtained by introducing a substituent such as an alkyl amino group, carboxy group, sulfonic acid group, phthalimide group etc. to the phthalocyanine pigment (B1).

Examples of commercially available phthalocyanine pigment derivatives (F) include “SOLSPERSE 5000”, “SOLSPERSE 12000” (both products of The Lubrizol Corporation), and “EFKA6745” (product of Efka Additives). They can be used singly, or in a combination of two or more.

When the aqueous coating composition of the present invention contains the phthalocyanine pigment derivative (F), the content of the phthalocyanine pigment derivative (F) preferably falls within 1 to 50 parts by mass, more preferably 2 to 30 parts by mass, further preferably 3 to 15 parts by mass, based on 100 parts by mass of the solids content of the condensed polycyclic pigment (B).

The phthalocyanine pigment derivative (F) may be added in the step of preparing the pigment, or in the step of dispersing the pigment during the production of the coating composition.

If necessary, the aqueous coating composition of the present invention may contain luster pigments other than the aluminium pigment (A) treated with molybdic acid, coloring pigments other than the condensed polycyclic pigment (B), extender pigments, hydrophobic organic solvents, thickeners, curing catalysts, resins for dispersing the pigments, the basic neutralizing agents, UV absorbers, light stabilizers, antifoaming agents, plasticizers, surface control agents, antisettling agents, etc.

Examples of the luster pigments other than the aluminium pigment (A) treated with molybdic acid include aluminiums not treated with molybdic acid (including evaporated aluminium), copper, zinc, brass, nickel, aluminium oxide, mica, aluminium oxide coated with titanium oxide or iron oxide, mica coated with titanium oxide or iron oxide, etc. Such luster pigments can be used singly, or in a combination of two or more. These pigments preferably have a scale-like shape.

Preferably used scaly luster pigments have a length in the longitudinal direction of about 1 to 100 μm, preferably about 5 to 40 μm; and a thickness of about 0.001 to 5 μm, preferably about 0.01 to 2 μm.

When the aqueous coating composition of the present invention contains luster pigments other than the aluminium pigment (A) treated with molybdic acid, the content of the luster pigment other than the aluminium pigment (A) treated with molybdic acid is generally preferably about 1 to 50 parts by mass, more preferably about 5 to 40 parts by mass, further preferably about 10 to 30 parts by mass, based on 100 parts by mass of the solids content of the film-forming resin (D).

The aqueous coating composition of the present invention may further contain, in addition to the resin (C) having an aromatic ring with a nitro group bonded thereto and the film-forming resin (D), a phosphoric acid group-containing resin as a resin component. In particular, when the aqueous coating composition of the present invention contains the above-mentioned luster pigment, especially an aluminium pigment, it is preferable that the aqueous coating composition of the present invention contain the phosphoric acid group-containing resin, in view of the smoothness, reduction in metallic mottling, and water resistance of the resulting coating film.

The above-mentioned phosphoric acid group-containing resin can be produced, for example, by copolymerizing the phosphoric acid group-containing polymerizable unsaturated monomer and the other polymerizable unsaturated monomer(s) by solution polymerization or other known methods. Examples of the above-mentioned phosphoric acid group-containing polymerizable unsaturated monomer include acid phosphoxyethyl(meth)acrylate, acid phosphoxypropyl(meth)acrylate, reaction products of glycidyl(meth)acrylate and alkyl phosphoric acid, etc. They can be used singly, or in a combination of two or more.

In the above-mentioned phosphoric acid group-containing resin, the mass ratio of the above-mentioned phosphoric acid group-containing polymerizable unsaturated monomer to the other polymerizable unsaturated monomer(s) in their copolymerization is preferably about 1/99 to 40/60, more preferably about 5/95 to 35/65, and even more preferably about 10/90 to 30/70.

When the aqueous coating composition of the present invention contains the above-mentioned phosphoric acid group-containing resin, the amount of the phosphoric acid group-containing resin is preferably about 0.5 to 15 parts by mass, more preferably about 0.75 to 10 parts by mass, and even more preferably about 1 to 5 parts by mass, based on 100 parts by mass of the film-forming resin (D).

Examples of the coloring pigments other than the condensed polycyclic pigment (B) include titanium oxide; zinc oxide; carbon black; cobalt blue; azo pigments such as permanent red, disazo yellow etc.; and dioxazine pigments such as carbazole violet etc. These pigments can be used singly, or in a combination of two or more.

Examples of the extender pigments include talc, clay, kaolin, baryta, barium sulfate, barium carbonate, calcium carbonate, silica, alumina white, etc.

The hydrophobic solvent is preferably an organic solvent having a solubility such that its soluble mass at 20° C. in 100 g of water is 10 g or less, preferably 5 g or less, and more preferably 1 g or less. Examples of such organic solvents include rubber solvents, mineral spirits, toluene, xylene, solvent naphtha, and like hydrocarbon solvents; 1-hexanol, 1-octanol, 2-octanol, 2-ethyl-1-hexanol, 1-decanol, benzyl alcohol, ethylene glycol mono-2-ethylhexyl ether, propylene glycol mono-n-butyl ether, dipropylene glycol mono-n-butyl ether, tripropylene glycol mono-n-butyl ether, propylene glycol mono-2-ethylhexyl ether, propylene glycol monophenyl ether, and like alcohol solvents; n-butyl acetate, isobutyl acetate, isoamyl acetate, methylamyl acetate, ethylene glycol monobutyl ether acetate, and like ester solvents; and methyl isobutyl ketone, cyclohexanone, ethyl n-amyl ketone, diisobutyl ketone, and like ketone solvents. These organic solvents can be used singly, or in a combination of two or more.

To ensure excellent luster of the resulting coating film, it is preferable to use an alcoholic hydrophobic organic solvent, more preferably an alcoholic hydrophobic organic solvent having 7 to 14 carbon atoms, as the hydrophobic organic solvent. Among them, it is preferable to use at least one member selected from the group consisting of 1-octanol, 2-octanol, 2-ethyl-1-hexanol, ethylene glycol mono-2-ethylhexyl ether, propylene glycol mono-n-butyl ether, and dipropylene glycol mono-n-butyl ether. 2-ethyl-1-hexanol and/or ethylene glycol mono-2-ethylhexyl ether are particularly preferable.

When the aqueous coating composition of the present invention contains the above-mentioned hydrophobic organic solvent, the amount of the hydrophobic organic solvent is preferably about 10 to 100 parts by mass, more preferably about 15 to 80 parts by mass, and even more preferably about 20 to 60 parts by mass, based on 100 parts by mass of the solids content of the aqueous coating composition.

Examples of thickeners include inorganic thickeners such as silicate, metal silicate, montmorillonite, colloidal alumina, etc.; polyacrylic acid thickeners such as copolymers of (meth)acrylic acid and (meth)acrylic ester, sodium polyacrylate, etc.; associative thickeners having a hydrophilic moiety and a hydrophobic moiety per molecule, and capable of effectively increasing the viscosity in an aqueous medium by adsorption of the hydrophobic moiety on the surface of pigments or emulsion particles in a coating composition or by association between hydrophobic moieties; cellulose derivative thickeners such as carboxymethylcellulose, methylcellulose, hydroxyethylcellulose, etc.; protein thickeners such as casein, sodium caseinate, ammonium caseinate, etc.; alginate thickeners such as sodium alginate, etc.; polyvinyl thickeners such as polyvinyl alcohol, polyvinylpyrrolidone, polyvinyl benzyl ether copolymers, etc.; polyether thickeners such as polyether dialkyl ester, polyether dialkyl ether, polyether epoxy-modified products, etc.; maleic anhydride copolymer thickeners such as partial esters of a copolymer of vinyl methyl ether and maleic anhydride, etc.; polyamide thickeners such as polyamide amine salts, etc.; and the like. Such thickeners can be used singly, or in a combination of two or more. Among these, polyacrylic acid thickeners and/or associative thickeners are preferably used.

Examples of polyacrylic acid thickeners include commercially available products, which are available, for example, under the tradenames “PRIMAL ASE-60”, “PRIMAL TT-615”, and “PRIMAL RM-5”, manufactured by Rohm and Haas; “SN Thickener 613”, “SN Thickener 618”, “SN Thickener 630”, “SN Thickener 634”, and “SN Thickener 636”, manufactured by San Nopco Ltd.; and the like. Examples of associative thickeners include commercially available products, which are available, for example, under the tradenames “UH-420”, “UH-450”, “UH-462”, “UH-472”, “UH-540”, “UH-752”, “UH-756VF”, and “UH-814N”, manufactured by ADEKA Co. Ltd.; “PRIMAL RM-8W”, “PRIMAL RM-825”, “PRIMAL RM-2020NPR”, “PRIMAL RM-12W”, and “PRIMAL SCT-275”, manufactured by Rohm and Haas; “SN Thickener 612”, “SN Thickener 621N”, “SN Thickener 625N”, “SN Thickener 627N”, and “SN Thickener 660T”, manufactured by San Nopco Ltd.; and the like.

When the aqueous coating composition of the present invention contains such a thickener, the amount of the thickener is preferably about 0.005 to 10 parts by mass, more preferably about 0.01 to 3 parts by mass, further preferably about 0.05 to 2 parts by mass, per 100 parts by mass of the solids content of the aqueous coating composition.

It is usually preferable that the solids content of the aqueous coating composition of the present invention be about 5 to 50 mass %, more preferably about 15 to 40 mass %, and further preferably about 20 to 30 mass %.

### Method of Forming Coating Films

The aqueous coating composition of the present invention can be applied on various substrates to be coated, thereby forming coating films having an excellent appearance.

### Substrates to be Coated

The substrates to which the aqueous coating composition of the present invention is applied are not particularly limited. Examples of the substrates include exterior body panels of vehicles such as cars, trucks, motorbikes, buses, etc.; automobile parts; and exterior panels of home electric appliances such as mobile phones, audio equipment, etc. Among these, vehicle body exterior panels and automobile parts are preferable.

Materials of these substrates are not particularly limited. Examples thereof include iron, aluminum, brass, copper, tin, stainless steel, galvanized steel, zinc alloy (Zn—Al, Zn—Ni, Zn—Fe, etc.) steel sheet, and like metal materials; resins such as polyethylene resin, polypropylene resin, acrylonitrile butadiene styrene (DBS) resin, polyamide resin, acrylic resin, vinylidene chloride resin, polycarbonate resin, polyurethane resin, epoxy resin etc., various FRPs, and like plastic materials; glass, cement, concrete, etc. and like inorganic materials; wood; paper, cloth, and like fiber materials; etc. Among these, metal materials and plastic materials are preferable.

The substrate to be coated may be a metal material as described above and a vehicle body formed from such metal material, whose metal surface has been subjected to a surface treatment such as phosphate treatment, chromate treatment, composite oxide treatment, etc. The substrate may also be such metal material, vehicle body, or the like as described above on which a coating film is further formed.

Examples of the substrates on which a coating film is formed include one in which a surface treatment is performed on the base material, if necessary, and an undercoating film is formed thereon; one in which an intermediate coating film is formed on the undercoating film; and the like.

### Coating Method

After forming a wet coating film (uncured coating film) by applying the aqueous coating composition of the present invention to a substrate, the wet coating film is cured, thereby forming a desired coating film.

The coating method of the aqueous coating composition of the present invention is not particularly limited. Examples thereof include air spray coating, airless spray coating, rotary atomization coating, curtain coating, etc. A wet coating film can be formed by these coating methods. Among these, methods such as air spray coating, rotary atomization coating, etc. are preferable. If necessary, static electricity may be used during coating.

The aqueous coating composition of the present invention is usually applied to a cured film thickness of about 5 to 50 μm, preferably about 5 to 35 μm, more preferably about 8 to 25 μm.

A wet coating film can be cured by heating a substrate after the aqueous coating composition of the present invention is applied to the substrate. Heating can be carried out by known heating means. For example, drying furnaces such as a hot air furnace, an electrical furnace, an infrared induction heating furnace, and the like may be used. The heating temperature is preferably about 80° C. to 180° C., more preferably about 100° C. to 170° C., and further preferably about 120° C. to 160° C. The heating time is not particularly limited, and is usually preferably about 10 to 60 minutes, further preferably about 20 to 40 minutes.

In order to prevent coating film defects such as popping and the like, after application of the aqueous coating composition of the present invention, it is preferable to perform preheating, air blowing, etc. under heating conditions in which the coating film does not substantially cure prior to the above-described heat curing. The preheating temperature is preferably about 40° C. to 100° C., more preferably about 50° C. to 90° C., further preferably about 60° C. to 80° C. The preheating time is preferably about 30 seconds to 15 minutes, more preferably about 1 to 10 minutes, further preferably about 2 to 5 minutes. Further, the above-described air blowing can usually be performed by blowing air of room temperature or air heated to a temperature of about 25° C. to 80° C. to the coated surface of the substrate for about 30 seconds to 15 minutes.

When forming a multilayer coating film comprising a base coating film and a clear coating film on a substrate such as a vehicle body and the like by a two-coat one-bake method, the aqueous coating composition of the present invention can be suitably used as a composition for forming the base coating film. A method of forming a coating film in this case can be carried out according to the below-described method I.

### Method I

A method of forming a multilayer coating film, comprising the steps of:

(1) applying the aqueous coating composition of the present invention to a substrate to be coated to form a base coating film;

(2) applying a clear coating composition on the surface of the uncured base coating film to form a clear coating film; and

(3) heating and simultaneously curing both the uncured base coating film and the uncured clear coating film.

The substrate in method I is preferably a vehicle body or the like on which an undercoating film and/or an intermediate coating film is formed. In the present invention, the cured coating film refers to a film in a dry-hard condition according to JIS K 5600-1-1 (2004), i.e., a condition in which imprints due to fingerprints are not formed on the coated surface and no movement is detected on the coating film when the center of the coated surface is strongly pinched with a thumb and an index finger, and in which scrapes are unobservable on the coated surface when the center of the coated surface is rubbed rapidly and repeatedly with a fingertip. On the other hand, the uncured coating film refers to a film that has not yet reached a dry-hard condition, including a film in a set-to-touch condition and a film in a dry-to-touch condition according to JIS K 5600-1-1.

When the aqueous coating composition of the present invention is applied by the two-coat one-bake method of method I, the coating film thickness (the cured film thickness) is preferably about 5 to 30 μm, more preferably about 7 to 18 μm, further preferably about 10 to 15 μm. Further, the coating film thickness (the cured film thickness) of the above-described clear coating composition is preferably about 10 to 80 μm, more preferably about 15 to 60 μm.

Further, in method I, in order to prevent coating film defects such as popping and the like, after application of the above-described aqueous coating composition, it is preferable to perform preheating, air blowing, etc. under heating conditions in which the coating film does not substantially cure. The preheating temperature is preferably about 40° C. to 100° C., more preferably about 50° C. to 90° C., further preferably about 60° C. to 80° C. The preheating time is preferably about 30 seconds to 15 minutes, more preferably about 1 to 10 minutes, further preferably about 2 to 5 minutes. Further, the above-described air blowing can usually be performed by blowing air of room temperature or air heated to a temperature of about 25° C. to 80° C. to the coated surface of the substrate for about 30 seconds to 15 minutes. Additionally, after application of the clear coating composition, it is possible, if necessary, to have an interval of about 1 to 60 minutes at room temperature, or to perform preheating at about 40° C. to 80° C. for about 1 to 60 minutes.

The aqueous coating composition and clear coating composition can be cured by using the above-described known heating means. The heating temperature is preferably about 80° C. to 180° C., more preferably about 100° C. to 170° C., and further preferably about 120° C. to 160° C. Further, the heating time is preferably about 10 to 60 minutes, more preferably about 20 to 40 minutes. Both coating films, i.e., the base coating film and the clear coating film, can be simultaneously cured by such heating.

Further, when forming a multilayer coating film comprising an intermediate coating film, a base coating film, and a clear coating film on a substrate to be coated such as a vehicle body or the like by a 3-coat 1-bake method, the aqueous coating composition of the present invention can be suitably used for forming the base coating film. A method of forming a coating film in this case may be carried out in accordance with the below-described method II.

### Method II

A method of forming a multilayer coating film, comprising the steps of:

(1) applying an intermediate coating composition to a substrate to be coated to form an intermediate coating film;

(2) applying the aqueous coating composition of the present invention on the surface of the uncured intermediate coating film to form a base coating film;

(3) applying a clear coating composition on the surface of the uncured base coating film to form a clear coating film; and

(4) simultaneously heat-curing the uncured intermediate colored coating film, uncured base coating film, and uncured clear coating film.

In method II, the method of forming a coating film in method I is carried out on the uncured intermediate coating film. Preferred substrates in method II include a vehicle body and the like having an undercoating film formed thereon. The above-described undercoating film is preferably formed by using electrodeposition coating materials, and further preferably formed by using cationic electrodeposition coating materials.

In method II, the coating film thickness (the cured film thickness) of the intermediate coating composition is usually preferably about 5 to 60 μm, more preferably about 10 to 40 μm, and further preferably about 15 to 30 μm. Further, the coating film thickness (the cured film thickness) of the aqueous coating composition of the present invention is preferably about 5 to 30 μm, more preferably 7 to 18 μm, further preferably about 10 to 15 μm. Additionally, the coating film thickness (the coating film thickness) of the clear coating composition is usually preferably about 10 to 80 μm, more preferably about 15 to 60 μm.

Further, when the aqueous intermediate coating composition is used as the intermediate coating composition in method II, after application of the aqueous intermediate coating composition, it is preferable to perform preheating, air blowing, etc. under heating conditions in which the coating film does not substantially cure in order to prevent coating film defects such as popping and the like. The preheating temperature is preferably about 40° C. to 100° C., more preferably about 50° C. to 90° C., further preferably about 60° C. to 80° C. The preheating time is preferably about 30 seconds to 15 minutes, more preferably about 1 to 10 minutes, further preferably about 2 to 5 minutes. Further, the above-described air blowing can usually be performed by blowing air of room temperature or air heated to a temperature of about 25° C. to 80° C. to the coated surface of the substrate for about 30 seconds to 15 minutes.

Further, in method II, after application of the above-described aqueous coating composition, it is preferable to perform preheating, air blowing, etc. under heating conditions in which the coating film does not substantially cure in order to prevent coating film defects such as popping and the like. The preheating temperature is preferably about 40° C. to 100° C., more preferably about 50° C. to 90° C., further preferably about 60° C. to 80° C. The preheating time is preferably about 30 seconds to 15 minutes, more preferably about 1 to 10 minutes, further preferably about 2 to 5 minutes. Further, the above-described air blowing can usually be performed by blowing air of room temperature or air heated to a temperature of about 25° C. to 80° C. to the coated surface of the substrate for about 30 seconds to 15 minutes. Additionally, after application of the clear coating composition, it is possible, if necessary, to have an interval of about 1 to 60 minutes at room temperature, or to perform preheating at about 40° C. to 80° C. for about 1 to 60 minutes.

The three-layered coating film, i.e., the uncured intermediate coating film, uncured base coating film, and uncured clear coating film, can be heat-cured by the above-described known heating means. The heating temperature is preferably about 80 to 180° C., more preferably about 100 to 170° C., further preferably about 120 to 160° C. Further, the heating time is preferably about 10 to 60 minutes, more preferably about 20 to 40 minutes. The three-layered coating film, i.e., the intermediate coating film, base coating film, and clear coating film, can be simultaneously cured by such heating.

Any thermosetting clear coating composition known as a composition for coating vehicle bodies and the like can be used as the clear coating composition used in methods I and II. Examples thereof include organic solvent-type thermosetting coating compositions, aqueous thermosetting coating compositions, powder thermosetting coating compositions, and the like, which comprise a crosslinking agent and a crosslinkable functional group-containing base resin.

Examples of crosslinkable functional groups contained in the base resin include carboxy, hydroxy, epoxy, silanol, and the like. Types of base resins include, for example, acrylic resins, polyester resins, alkyd resins, urethane resins, epoxy resins, fluorine resins, and the like. Examples of crosslinking agents include polyisocyanate compounds, blocked polyisocyanate compounds, melamine resins, urea resins, carboxy-containing compounds, carboxy-containing resins, epoxy-containing resins, epoxy-containing compounds, and the like.

Additionally, the clear coating composition may be a one-component coating material, or a multiple-component coating material such as a two-component urethane resin coating material, etc.

Further, if necessary, coloring pigments, luster pigments, dyes, etc. may be added to the clear coating composition, without impairing the transparency thereof. Still further, extender pigments, UV absorbers, light stabilizers, antifoaming agents, thickening agents, anticorrosives, surface control agents, etc. may also be suitably included.

Preferable combinations of the base resin/crosslinking agent in the clear coating composition include carboxy-containing resin/epoxy-containing resin, hydroxy-containing resin/polyisocyanate compound, hydroxy-containing resin/blocked polyisocyanate compound, hydroxy-containing resin/melamine resin, and the like.

As the intermediate coating compositions used in method II, for example, any known thermosetting intermediate coating compositions can be used. For example, a thermosetting coating composition containing a crosslinkable functional group-containing base resin, crosslinking agent, coloring pigment, and extender pigment may be suitably used.

Examples of crosslinkable functional groups present in the base resins include carboxy, hydroxy, epoxy, and the like. Types of base resins include, for example, acrylic resins, polyester resins, alkyd resins, urethane resins, etc. Examples of crosslinking agents include melamine resins, polyisocyanate compounds, blocked polyisocyanate compounds, etc.

Any of organic solvent-type coating compositions, aqueous coating compositions, and powder coating compositions may be used as the intermediate coating composition. Among these, an aqueous coating composition is preferably used.

In methods I and II, the intermediate coating composition and the clear coating composition can be applied by any known method. Examples of such methods include air spray coating, airless spray coating, rotary atomization coating, and the like.

### EXAMPLES

Hereinbelow, the present invention is described in further detail with reference to Production Examples, Examples, and Comparative Examples. However, the present invention is not limited thereto. In each example, “part(s)” and “%” are based on mass unless otherwise specified. Additionally, the film thickness of a coating film is on a cured basis.

### Production of Polymerizable Unsaturated Monomer (a) Having an Aromatic Ring with Nitro Group Bonded Thereto

### Production Example 1

167 parts of 4-nitrobenzoic acid, 170 parts of ethylene glycol mono-n-butyl ether, 1.5 parts of hydroquinone monomethyl ether (MEHQ), and 1.5 parts of tetrabutyl ammonium bromide were placed into a four-necked reaction vessel equipped with a thermometer, a thermostat, a stirring device, a reflux condenser, an air introducing pipe, and a dropping funnel. The mixture was then heated to 130° C. under stirring while dry air was blown into the vessel. When the temperature reached 130° C., 149 parts of glycidyl methacrylate was added dropwise thereinto over 1.5 hours. Thereafter, the reaction system was aged at 130° C. for 2 hours while introducing dry air into the reaction liquid by bubbling, then cooled to room temperature, producing a polymerizable unsaturated monomer solution (a-1) having a solids content of 65% (structural Formula (a-1) shown below).

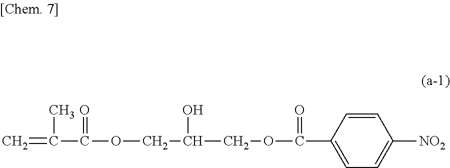

### Production Example 2

167 parts of 3-nitrobenzoic acid, 170 parts of ethylene glycol mono-n-butyl ether, 1.5 parts of hydroquinone monomethyl ether (MEHQ), and 1.5 parts of tetrabutyl ammonium bromide were placed into a four-necked reaction vessel equipped with a thermometer, a thermostat, a stirring device, a reflux condenser, an air introducing pipe, and a dropping funnel. The mixture was then heated to 130° C. under stirring while dry air was blown into the vessel. When the temperature reached 130° C., 149 parts of glycidyl methacrylate was added dropwise thereinto over 1.5 hours. Thereafter, the reaction system was aged at 130° C. for 2 hours while introducing dry air into the reaction liquid by bubbling, then cooled to room temperature, producing a polymerizable unsaturated monomer solution (a-2) having a solids content of 65% (structural Formula (a-2) shown below).

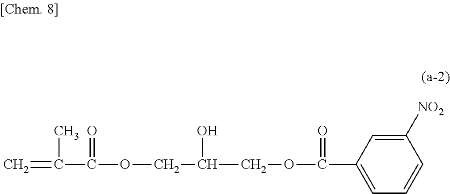

### Production of Other Polymerizable Unsaturated Monomers (b)

### Production Example 3

122 parts of benzoic acid, 146 parts of ethylene glycol mono-n-butyl ether, 1.5 parts of hydroquinone monomethyl ether (MEHQ), and 1.5 parts of tetrabutyl ammonium bromide were placed into a four-necked reaction vessel equipped with a thermometer, a thermostat, a stirring device, a reflux condenser, an air introducing pipe, and a dropping funnel. The mixture was then heated to 130° C. under stirring while dry air was blown into the vessel. When the temperature reached 130° C., 149 parts of glycidyl methacrylate was added dropwise thereinto over 1.5 hours. Thereafter, the reaction system was aged at 130° C. for 1.5 hours while introducing dry air into the reaction liquid by bubbling, then cooled to room temperature, producing a polymerizable unsaturated monomer solution (b-1) having a solids content of 65%.

### Production of Resin Composition

### Production Example 4

35 parts of ethylene glycol mono-n-butyl ether was placed into a reaction vessel equipped with a thermometer, a thermostat, a stirring device, a reflux condenser, a nitrogen introducing pipe, and a dropping funnel, and the reaction system was heated to 95° C. Subsequently, a monomer mixture (1) comprising 31 parts of the polymerizable unsaturated monomer solution (a-1) obtained in Production Example 1 (20 parts of solids content), 10 parts of styrene, 10 parts of 2-hydroxyethyl acrylate, 40 parts of methyl methacrylate and 4 parts of dimethyl-2,2′-azobisisobutyrate, and a monomer mixture (2) comprising 40 parts (20 parts of solids content) of “NF Bisomer S20W” (tradename, Dai-Ichi Kogyo Seiyaku Co, Ltd., a polymerizable unsaturated monomer having a polyoxyalkylene chain, a 50% water-diluted product of methoxy polyethylene glycol monomethacrylate represented by Formula (4) in which R³ is a methyl group, R⁴ is a methyl group, R⁵ is an ethylene group, m is 45, having a molecular weight of about 2,000) and 20 parts of ethylene glycol mono-n-butyl ether were added dropwise in parallel over 3 hours. After completion of the dropwise addition, the reaction system was aged for one hour, and a mixture comprising 10 parts of ethylene glycol mono-n-butyl ether and 1 part of dimethyl-2,2′-azobisisobutyrate was further added dropwise over 1 hour. After completion of the dropwise addition, the reaction system was aged for one hour, and 4 parts of ethylene glycol mono-n-butyl ether was added thereto. 25 parts of the reaction solvent was then collected at reduced pressure and at 95° C. Subsequently, the collected product was diluted by adding thereto 25 parts of ethylene glycol monomethyl ether, producing a resin composition (C-1) having a solids content of 50%. The obtained resin had a hydroxy value of 84 mg KOH/g, and a weight average molecular weight of 27,000.

### Production Example 5

35 parts of ethylene glycol mono-n-butyl ether was placed into a reaction vessel equipped with a thermometer, a thermostat, a stirring device, a reflux condenser, a nitrogen introducing pipe, and a dropping funnel, and the reaction system was heated to 95° C. Subsequently, a monomer mixture (1) comprising 31 parts of the polymerizable unsaturated monomer solution (a-1) obtained in Production Example 1 (20 parts of solid component), 4 parts of styrene, 4 parts of 2-hydroxyethyl acrylate, 42 parts of methyl methacrylate and 4 parts of dimethyl-2,2′-azobisisobutyrate, and a monomer mixture (2) comprising 60 parts (30 parts of solids content) of “NF Bisomer S10W” (tradename, Dai-Ichi Kogyo Seiyaku Co, Ltd., a polymerizable unsaturated monomer having a polyoxyalkylene chain, a 50% water-diluted product of methoxy polyethylene glycol monomethacrylate represented by Formula (4) wherein R³ is a methyl group, R⁴ is a methyl group, R⁵ is an ethylene group, m is 21, having a molecular weight of about 1,000) and 20 parts of ethylene glycol mono-n-butyl ether were added dropwise in parallel over 3 hours. After completion of the dropwise addition, the reaction system was aged for one hour, and a mixture comprising 10 parts of ethylene glycol mono-n-butyl ether and 1 part of dimethyl-2,2′-azobisisobutyrate was further added dropwise over 1 hour. After completion of the dropwise addition, the reaction system was aged for one hour, and 4 parts of ethylene glycol mono-n-butyl ether was added thereto. 35 parts of the reaction solvent was then collected at reduced pressure and at 95° C. Subsequently, the collected product was diluted by adding thereto 25 parts of ethylene glycol monomethyl ether, producing a resin composition (C-2) having a solids content of 50%. The obtained resin had a hydroxy value of 55 mg KOH/g, and a weight average molecular weight of 22,000.

### Production Example 6

37 parts of ethylene glycol mono-n-butyl ether was placed into a reaction vessel equipped with a thermometer, a thermostat, a stirring device, a reflux condenser, a nitrogen introducing pipe, and a dropping funnel, and the reaction system was heated to 115° C. Subsequently, a mixture of 38 parts (25 parts of solids content) of the polymerizable unsaturated monomer solution (a-1) obtained in Production Example 1, 10 parts of styrene, 5 parts of 2-hydroxyethyl acrylate, 15 parts of “PLACCEL FM-3” (tradename, Daicel Chemical Industries, Ltd., a monomer formed by adding 3 mols of ε-caprolactone per mol of 2-hydroxyethyl methacrylate), 38 parts of methyl methacrylate, 7 parts of methacrylic acid, 20 parts of ethylene glycol monomethyl ether and 4 parts of dimethyl-2,2′-azobisisobutyrate was added dropwise over 4 hours. After the completion of the addition, the reaction system was aged for one hour, and a mixture of 10 parts of ethylene glycol mono-n-butyl ether and 0.5 parts of dimethyl-2,2′-azobisisobutyrate was further added thereto dropwise over 1 hour. After completion of the dropwise addition, the reaction system was aged for one hour, and was diluted by adding 15 parts of ethylene glycol monomethyl ether, producing a resin composition (C-3) having a solids content of 50%. The obtained resin had a hydroxy value of 87 mg KOH/g, an acid value of 46 mg KOH/g, and a weight average molecular weight of 34,000.

### Production Examples 7 to 8, and 10 to 14

Resin compositions (C-4), (C-5), and (C-7) to (C-11) were obtained in the same manner as in Production Example 4, except that the composition shown in Table 1 was used.

### Production Example 9

A resin composition (C-6) was obtained in the same manner as in Production Example 4, except that the composition shown in Table 1 was used, and the amount of the collected reaction solvent was 30 parts.

Table 1 shows the composition of raw materials (parts), solids content (%), hydroxy value (mg KOH/g), acid value (mg KOH/g), and weight average molecular weight of the resin compositions (C-1) to (C-11).

TABLE 1

| | | | Production Example | | | | | | | | | | |
|---|---|---|---|---|---|---|---|---|---|---|---|---|---|
| | | | 4 | 5 | 6 | 7 | 8 | 9 | 10 | 11 | 12 | 13 | 14 |
| Resin composition | | | C-1 | C-2 | C-3 | C-4 | C-5 | C-6 | C-7 | C-8 | C-9 | C-10 | C-11 |
| Ethylene glycolmono-n-butylether | | | 35 | 35 | 37 | 35 | 35 | 35 | 35 | 35 | 35 | 35 | 35 |
| Monomer | Polymerizable | Polymerizable | 31 | 31 | 38 | | 31 | 38 | 31 | 31 | 31 | 31 | |
| mixture | unsaturated | unsaturated monomer | | | | | | | | | | | |
| (1) | monomer (a) | solution (a-1) | | | | | | | | | | | |
| | | Polymerizable | | | | 31 | | | | | | | |
| | | unsaturated monomer | | | | | | | | | | | |
| | | solution (a-2) | | | | | | | | | | | |
| | Polymerizable | Styrene | 10 | 4 | 10 | 10 | | 10 | 10 | 10 | 10 | 10 | 10 |
| | unsaturated | 2-hydroxyethylacrylate | 10 | 4 | 5 | | 5 | | 10 | 10 | 10 | 10 | 10 |
| | monomer (b) | 4-hydroxybutylacrylate | | | | 10 | | | | | | | |
| | | “PLACCEL FM-3” | | | 15 | | | | | | | | |
| | | Methylmethacrylate | 40 | 42 | 38 | 40 | 55 | 40 | 5 | 35 | 37 | 34 | 40 |
| | | n-butylacrylate | | | | | | | 35 | | | | |
| | | Dimethylaminoethyl | | | | | | | | 5 | | 5 | |
| | | methacrylate | | | | | | | | | | | |
| | | 2-(methacryloyloxy)ethy] | | | | | | | | | 3 | 1.5 | |
| | | trimethylammonium | | | | | | | | | | | |
| | | chloride | | | | | | | | | | | |
| | | Methacrylic acid | | | 7 | | | | | | | | |
| | | Polymerizable | | | | | | | | | | | 31 |
| | | unsaturated monomer | | | | | | | | | | | |
| | | solution (b-1) | | | | | | | | | | | |
| | Dimethyl-2,2′-azobisisobutyrate | | 4 | 4 | 4 | 4 | 4 | 4 | 4 | 4 | 4 | 4 | 4 |
| | Ethylene glycolmonomethylether | | | | 20 | | | | | | | | |
| Monomer | Polymerizable | “NFB isomer S20W” | 40 | | | 40 | 40 | 50 | 40 | 40 | 40 | 40 | 40 |
| mixture | unsaturated | “NFB isomer S10W” | | 60 | | | | | | | | | |
| (2) | monomer (b) | | | | | | | | | | | | |

| | | | | | | | | | | |
|---|---|---|---|---|---|---|---|---|---|---|
| Ethylene glycolmono-n-butylether | 20 | 20 | 20 | 20 | 20 | 20 | 20 | 20 | 20 | 20 |

| | | | | | | | | | | | |
|---|---|---|---|---|---|---|---|---|---|---|---|
| Ethylene glycolmono-n-butylether | 10 | 10 | 10 | 10 | 10 | 10 | 10 | 10 | 10 | 10 | 10 |
| Dimethyl-2,2′-azobisisobutyrate | 1 | 1 | 0.5 | 1 | 1 | 1 | 1 | 1 | 1 | 1 | 1 |
| Ethylene glycolmono-n-butylether | 4 | 4 | | 4 | 4 | 4 | 4 | 4 | 4 | 4 | 4 |
| Ethylene glycolmonomethylether | 25 | 25 | 20 | 25 | 25 | 25 | 25 | 25 | 25 | 25 | 25 |
| Solids content (mass %) | 50 | 50 | 50 | 50 | 50 | 50 | 50 | 50 | 50 | 50 | 50 |
| Hydroxy value (mgKOH/g) | 84 | 55 | 87 | 75 | 84 | 45 | 84 | 84 | 84 | 84 | 48 |
| Acid value (mgKOH/g) | 0 | 0 | 46 | 0 | 0 | 0 | 0 | 0 | 0 | 0 | 0 |
| Weight average molecular weight (×10³) | 27 | 22 | 34 | 30 | 25 | 33 | 28 | 20 | 21 | 23 | 25 |

Among the resin compositions (C-1) to (C-11) in Table 1, the resins (C-1) to (C-10) correspond to the resin (C) having an aromatic ring with a nitro group bonded thereto.

### Production of Hydroxy-Containing Acrylic Resin (D1)

### Production Example 15

128 parts of deionized water and 2 parts of “Adekaria Soap SR-1025” (product name, manufactured by ADEKA; emulsifier, active ingredient: 25%) were placed into a reaction vessel equipped with a thermometer, a thermostat, a stirring device, a reflux condenser, a nitrogen introducing pipe, and a dropping funnel. The mixture was stirred and mixed in nitrogen flow, and heated to 80° C.

Subsequently, 1% of the entire amount of monomer emulsion for the core portion, which is described below, and 5.3 parts of a 6% ammonium persulfate aqueous solution were introduced into the reaction vessel, and maintained therein at 80° C. for 15 minutes. Thereafter, the remaining monomer emulsion for the core portion was added dropwise over 3 hours to the reaction vessel maintained at the same temperature. After completion of the dropwise addition, the mixture was aged for 1 hour. Subsequently, the below-described monomer emulsion for the shell portion was added dropwise to the reaction vessel over 1 hour, followed by aging for 1 hour. Thereafter, the mixture was cooled to 30° C. while gradually adding 40 parts of a 5% 2-(dimethylamino)ethanol aqueous solution thereto, and filtered through a 100-mesh nylon cloth, thereby obtaining a water-dispersible hydroxy-containing acrylic resin water dispersion (D1-1) having a mean particle diameter of 100 nm and a solids content of 30%. The obtained water-dispersible hydroxy-containing acrylic resin had an acid value of 33 mg KOH/g, and a hydroxy value of 25 mg KOH/g.

A monomer emulsion for the core portion: 40 parts of deionized water, 2.8 parts of “Adekaria Soap SR-1025”, 2.1 parts of methylene bisacrylamide, 2.8 parts of styrene, 16.1 parts of methyl methacrylate, 28 parts of ethyl acrylate, and 21 parts of n-butyl acrylate were mixed and stirred, thereby obtaining a monomer emulsion for the core portion.

A monomer emulsion for the shell portion: 17 parts of deionized water, 1.2 parts of “Adekaria Soap SR-1025”, 0.03 parts of ammonium persulfate, 3 parts of styrene, 5.1 parts of 2-hydroxyethyl acrylate, 5.1 parts of methacrylic acid, 6 parts of methyl methacrylate, 1.8 parts of ethyl acrylate, and 9 parts of n-butyl acrylate were mixed and stirred, thereby obtaining a monomer emulsion for the shell portion.

Further, the water-dispersible hydroxy-containing acrylic resin (D1-1) corresponds to a core-shell-type water-dispersible hydroxy-containing acrylic resin (D1′).

### Production Example 16

35 parts of propylene glycol monopropyl ether was placed into a reaction vessel equipped with a thermometer, a thermostat, a stirring device, a reflux condenser, a nitrogen introducing pipe, and a dropping funnel, and heated to 85° C. Subsequently, a mixture comprising 30 parts of methyl methacrylate, 20 parts of 2-ethylhexyl acrylate, 29 parts of n-butyl acrylate, 15 parts of 2-hydroxyethyl acrylate, 6 parts of acrylic acid, 15 parts of propylene glycol monopropyl ether, and 2.3 parts of 2,2′-azobis(2,4-dimethylvaleronitrile) was added dropwise thereto over 4 hours. After completion of the dropwise addition, the mixture was aged for 1 hour. Subsequently, a mixture of 10 parts of propylene glycol monopropyl ether and 1 part of 2,2′-azobis(2,4-dimethylvaleronitrile) was further added dropwise thereto over 1 hour. After completion of the dropwise addition, the mixture was aged for 1 hour. 7.4 parts of diethanolamine was further added thereto, thereby obtaining a hydroxy-containing acrylic resin solution (D1-2) having a solids content of 55%. The obtained hydroxy-containing acrylic resin had an acid value of 47 mg KOH/g, and a hydroxy value of 72 mg KOH/g.

### Production of Hydroxy-Containing Polyester Resin (D2)

### Production Example 17

109 parts of trimethylolpropane, 141 parts of 1,6-hexanediol, 126 parts of 1,2-cyclohexanedicarboxylic acid anhydride, and 120 parts of adipic acid were placed into a reaction vessel equipped with a thermometer, a thermostat, a stirring device, a reflux condenser, and a water separator. The mixture was heated to a range of 160° C. to 230° C. over 3 hours, followed by a condensation reaction at 230° C. for 4 hours. Subsequently, to introduce a carboxy group to the obtained condensation reaction product, 38.3 parts of trimellitic anhydride was added to the product, followed by a reaction at 170° C. for 30 minutes. Thereafter, the product was diluted with 2-ethyl-1-hexanol (mass that dissolves in 100 g of water at 20° C.: 0.1 g), thereby obtaining a hydroxy-containing polyester resin solution (D2-1) having a solids content of 70%. The obtained hydroxy-containing polyester resin had an acid value of 46 mg KOH/g, a hydroxy value of 150 mg KOH/g, and a number average molecular weight of 1,400. In the composition of raw materials, the total content of alicyclic polybasic acid in the acid component was 46 mol % based on the total amount of the acid component.

### Production of Aluminium Pigment Dispersion

### Production Example 18

In a stirring and mixing container, 17 parts (solids content: 10 parts) of “ALPASTE WL-7640” (product name, manufactured by Toyo Aluminium K.K.; aluminium pigment paste treated with molybdic acid, aluminium content: 59%), 8 parts (solids content: 4 parts) of the phosphoric acid group-containing resin solution described below, 35 parts of 2-ethyl-1-hexanol (mass that dissolves in 100 g of water at 20° C.: 0.1 g), and 0.5 parts of 2-(dimethylamino)ethanol were uniformly mixed, thereby obtaining an aluminium pigment dispersion (PA-1).

Phosphoric acid group-containing resin solution: a mixture solvent of 27.5 parts of methoxypropanol and 27.5 parts of isobutanol was placed into a reaction vessel equipped with a thermometer, a thermostat, a stirring device, a reflux condenser, and a dropping funnel, and the mixture solvent was heated to 110° C. Subsequently, 121.5 parts of a mixture comprising 25 parts of styrene, 27.5 parts of n-butyl methacrylate, 20 parts of branched higher alkyl acrylate (product name “Isostearyl Acrylate”, manufactured by Osaka Organic Chemical Industry, Ltd.), 7.5 parts of 4-hydroxybutyl acrylate, 15 parts of the phosphoric acid group-containing polymerizable monomer described below, 12.5 parts of 2-methacryloyloxy ethyl acid phosphate, 10 parts of isobutanol, and 4 parts of tert-butyl peroxyoctanoate was added dropwise to the mixture solvent over 4 hours. Further, a mixture comprising 0.5 parts of tert-butyl peroxyoctanoate and 20 parts of isopropanol was added dropwise thereinto for 1 hour, followed by stirring for 1 hour for aging, thereby obtaining a phosphoric acid group-containing resin solution having a solids content of 50%. The phosphoric acid group-containing resin had an acid value of 83 mg KOH/g, a hydroxy value of 29 mg KOH/g, and a weight average molecular weight of 10,000.

Phosphoric acid group-containing polymerizable monomer: 57.5 parts of monobutyl phosphate and 41 parts of isobutanol were placed into a reaction vessel equipped with a thermometer, a thermostat, a stirring device, a reflux condenser, and a dropping funnel. After the mixture was heated to 90° C., 42.5 parts of glycidyl methacrylate was added dropwise thereinto over 2 hours, and further stirred for 1 hour for aging. Subsequently, 59 parts of isopropanol was added thereto, thereby obtaining a phosphoric acid group-containing polymerizable monomer solution having a solids content of 50%. The obtained monomer had an acid value of 285 mg KOH/g.

### Production Examples 19 to 27

Aluminium pigment dispersions (PA-2) to (PA-10) were obtained in the same manner as in Production Example 18, except that the composition shown in Table 2 was used.

TABLE 2

| | | | Production Example | | | | | | | | | |
|---|---|---|---|---|---|---|---|---|---|---|---|---|
| | | | 18 | 19 | 20 | 21 | 22 | 23 | 24 | 25 | 26 | 27 |
| Aluminium pigment dispersion | | | PA-1 | PA-2 | PA-3 | PA-4 | PA-5 | PA-6 | PA-7 | PA-8 | PA-9 | PA-10 |
| Aluminium | Aluminium | “ALPASTE WL-7640” | 17 | | | | | | | 17 | 17 | |
| pigment | pigment (A) | “ALPASTE WJP-U75C” (Note | | 16 | 2 | 98 | 16 | 39 | 59 | | | |
| | treated with | 1-1) | | | | | | | | | | |
| | molybdic acid | | | | | | | | | | | |
| | | “ALPASTE TCR-2060” (Note | | | | | 3 | | | | | |
| | | 1-2) | | | | | | | | | | |
| | | “ALPASTE 7640NS” (Note | | 3 | | | | | | | | 16 |
| | | 1-3) | | | | | | | | | | |

| | | | | | | | | | | |
|---|---|---|---|---|---|---|---|---|---|---|
| Phosphoric acid group-containing resin solution | 8 | 8 | 8 | 8 | 8 | 8 | 8 | 8 | 8 | 8 |
| 2-ethyl-1-hexanol | 35 | 35 | 35 | 90 | 35 | 50 | 70 | | 10 | 35 |
| Ethylene glycolmono-2-ethylhexylether (Note 2-1) | | | | | | | | | 25 | |
| Ethylene glycolmono-n-butylether (Note 2-2) | | | | | | | | 35 | | |
| 2-(dimethylamino)ethanol | 0.5 | 0.5 | 0.5 | 0.5 | 0.5 | 0.5 | 0.5 | 0.5 | 0.5 | 0.5 |

(Note 1-1) “ALPASTE WJP-U75C”: product name, manufactured by Toyo Aluminium K.K.; aluminium pigment paste treated with molybdic acid, aluminium content: 51%
(Note 1-2) “ALPASTE TCR-2060”: product name, manufactured by Toyo Aluminium K.K.; aluminium pigment paste not treated with molybdic acid, aluminium content: 74%
(Note 1-3) “ALPASTE 7640NS”: product name, manufactured by Toyo Aluminium K.K.; aluminium pigment paste not treated with molybdic acid, aluminium content: 64%
(Note 2-1) Ethylene glycol mono-2-ethylhexyl ether: the mass that dissolves in 100 g of water at 20° C.: 0.5 g
(Note 2-2) Ethylene glycol mono-n-butyl ether: the mass that dissolves in 100 g of water at 20° C.: unlimited

### Production of Pigment Dispersion

### Production Example 28

In a stirring and mixing container, 33 parts of (solids content: 18 parts) of the hydroxy-containing acrylic resin solution (D1-2) obtained in Production Example 16, 18 parts of “CYANINE BLUE G-314” (product name, manufactured by Sanyo Color Works, LTD.; α-type copper phthalocyanine pigment, C.I. Pigment Blue 15:1), 1.4 parts of “SOLSPERSE 12000” (product name, manufactured by LUBRISOL; phthalocyanine pigment derivative), and 54 parts of deionized water were uniformly mixed. Further, 2-(dimethylamino)ethanol was added thereto, and the pH of the mixture was adjusted to 7.5. The obtained mixture was then placed into a wide-mouthed glass bottle having a capacity of 225 ml. Glass beads having a diameter of about 1.3 mm were added to the bottle as a dispersion medium, which was then hermetically sealed, and the mixture was dispersed for 4 hours by a paint shaker, producing a pigment dispersion (PB-1).

### Production Examples 29 to 35

Pigment dispersions (PB-2) to (PB-8) were obtained in the same manner as in Production Example 28, except that the formulation composition shown in Table 3 was used.

TABLE 3

| | | Production Example | | | | | | | |
|---|---|---|---|---|---|---|---|---|---|
| | | 28 | 29 | 30 | 31 | 32 | 33 | 34 | 35 |
| Pigment dispersion | | PB-1 | PB-2 | PB-3 | PB-4 | PB-5 | PB-6 | PB-7 | PB-8 |
| Hydroxy-containing acrylic resin solution (D1-2) | | 33 | 33 | 33 | 33 | 33 | 33 | 33 | 33 |
| Phthalocyanine | “CYANINE BLUE G-314” | 18 | 18 | 18 | | | | | 29 |
| pigment (B) | “LIONOL BLUE 7185-PM” (Note 3) | | | | 18 | | | | |
| | “HELIOGEN BLUE L 7085” (Note 4) | | | | | 18 | | | |
| | “HELIOGEN BLUE L 6700 F” (Note | | | | | | 18 | | |
| | 5) | | | | | | | | |
| | “CYANINE BLUE 5000P” (Note 6) | | | | | | | 18 | |
| Phthalocyanine | “SOLSPERSE 12000” | 1.4 | | | 1.4 | 1.4 | 1.4 | 1.4 | 2.2 |
| pigment derivative (F) | “SOLSPERSE 5000” (Note 7) | | 1.4 | | | | | | |

| | | | | | | | | |
|---|---|---|---|---|---|---|---|---|
| Deionized water | 54 | 54 | 54 | 54 | 54 | 54 | 54 | 54 |

(Note 3) “LIONOL BLUE 7185-PM” (product name, Toyo Ink MFG Co., Ltd.; α-type copper phthalocyanine pigment, C.I. Pigment Blue 15:1)
(Note 4) “HELIOGEN BLUE L 7085” (product name, manufactured by BASF; β-type copper phthalocyanine pigment, C.I. Pigment Blue 15:3)
(Note 5) “HELIOGEN BLUE L 6700 F” (product name, manufactured by BASF; ε-type copper phthalocyanine pigment, C.I. Pigment Blue 15:6)
(Note 6) “CYANINE BLUE 5000P” (product name, manufactured by Dainichiseika Color & Chemicals Mfg. Co., Ltd.; cobalt phthalocyanine pigment, C.I. Pigment Blue 75)
(Note 7) “SOLSPERSE 5000” (product name, manufactured by LUBRISOL; phthalocyanine pigment derivative)

### Production of Aqueous Coating Composition

### Example 1

Added to a stirring and mixing container were: 100 parts of the water-dispersible hydroxy-containing acrylic resin water dispersion (D1-1) obtained in Production Example 15, 44 parts of the hydroxy-containing polyester resin solution (D2-1) obtained in Production Example 17, 50 parts of melamine resin (E-1) (methyl-butyl mixed etherified melamine resin; the solids content is 60%, the weight average molecular weight is 2,000), 60 parts of the aluminium pigment dispersion solution (PA-1) obtained in Production Example 18, 29 parts of the pigment dispersion (PB-1) obtained in Production Example 28, and 1.0 parts of the resin composition (C-1) obtained in Production Example 4; and the mixture was uniformly mixed. Further, “Primal ASE-60” (product name, manufactured by Rohm and Haas, polyacrylic acid thickener), 2-(dimethylamino)ethanol, and deionized water were added, thereby obtaining an aqueous coating composition (X-1) having a pH of 8.0, a solids content of 24%, and a viscosity of 50 seconds as measured at 20° C. using Ford Cup No. 4.

### Examples 2 to 20 and Comparative Examples 1 to 5

Aqueous coating compositions (X-2) to (X-25) having a pH of 8.0, a solids content of 25%, and a viscosity of 50 seconds as measured at 20° C. using Ford Cup No. 4 were obtained in the same manner as in Example 1, except that the formulation composition shown in Table 4 was used.

TABLE 4

| | | | Example | | | | | | | | |
|---|---|---|---|---|---|---|---|---|---|---|---|
| | | | 1 | 2 | 3 | 4 | 5 | 6 | 7 | 8 | 9 |
| Aqueous coating composition | | | X-1 | X-2 | X-3 | X-4 | X-5 | X-6 | X-7 | X-8 | X-9 |
| Film- | Hydroxy- | Water-dispersible | 100 | 100 | 100 | 100 | 100 | 100 | 100 | 100 | 100 |
| forming | containing | hydroxy-containing | | | | | | | | | |
| resin (D) | acrylic resin | acrylic resin water | | | | | | | | | |
| | (D1) | dispersion (D1-1) | | | | | | | | | |
| | Hydroxy- | Hydroxy-containing | 44 | 44 | 44 | 44 | 44 | 44 | 44 | 44 | 44 |
| | containing | polyester resin | | | | | | | | | |
| | polyester | solution (D2-1) | | | | | | | | | |
| | resin (D2) | | | | | | | | | | |
| Curing | Melamine | Melamine resin | 50 | 50 | 50 | 50 | 50 | 50 | 50 | 50 | 50 |
| agent (E) | resin | (E-1) | | | | | | | | | |
| Aluminium pigment | | Type | PA-1 | PA-2 | PA-1 | PA-1 | PA-1 | PA-1 | PA-1 | PA-1 | PA-1 |
| dispersion | | Quantity | 60 | 62 | 60 | 60 | 60 | 60 | 60 | 60 | 60 |
| Pigment dispersion | | Type | PB-1 | PB-1 | PB-1 | PB-1 | PB-1 | PB-1 | PB-1 | PB-1 | PB-1 |
| | | Quantity | 29 | 29 | 29 | 29 | 29 | 29 | 29 | 29 | 29 |
| Resin composition | | Type | C-1 | C-1 | C-2 | C-3 | C-4 | C-5 | C-6 | C-7 | C-8 |
| | | Quantity | 1.0 | 0.8 | 1.0 | 1.0 | 1.0 | 1.0 | 1.0 | 1.0 | 1.0 |
| | | | Example | | | | | | | | |
| | | | 10 | 11 | 12 | 13 | 14 | 15 | 16 | 17 | 18 |
| Aqueous coating composition | | | X-10 | X-11 | X-12 | X-13 | X-14 | X-15 | X-16 | X-17 | X-18 |
| Film- | Hydroxy- | Water-dispersible | 100 | 100 | 100 | 100 | 100 | 100 | 100 | 100 | 100 |
| forming | containing | hydroxy-containing | | | | | | | | | |
| resin (D) | acrylic resin | acrylic resin water | | | | | | | | | |
| | (D1) | dispersion (D1-1) | | | | | | | | | |
| | Hydroxy- | Hydroxy-containing | 44 | 44 | 44 | 44 | 44 | 44 | 44 | 44 | 44 |
| | containing | polyester resin | | | | | | | | | |
| | polyester | solution (D2-1) | | | | | | | | | |
| | resin (D2) | | | | | | | | | | |
| Curing | Melamine | Melamine resin | 50 | 50 | 50 | 50 | 50 | 50 | 50 | 50 | 50 |
| agent (E) | resin | (E-1) | | | | | | | | | |

| | | | | | | | | | | |
|---|---|---|---|---|---|---|---|---|---|---|
| Aluminium pigment | Type | PA-1 | PA-1 | PA-1 | PA-1 | PA-1 | PA-1 | PA-1 | PA-1 | PA-3 |
| dispersion | Quantity | 60 | 60 | 60 | 60 | 60 | 60 | 60 | 60 | 45 |
| Pigment dispersion | Type | PB-1 | PB-1 | PB-2 | PB-3 | PB-4 | PB-5 | PB-6 | PB-7 | PB-1 |
| | Quantity | 29 | 29 | 29 | 29 | 29 | 29 | 29 | 29 | 29 |
| Resin composition | Type | C-9 | C-10 | C-1 | C-1 | C-1 | C-1 | C-1 | C-1 | C-1 |
| | Quantity | 1.0 | 1.0 | 1.0 | 1.0 | 1.0 | 1.0 | 1.0 | 1.0 | 0.3 |

| | | | Example | | Comparative Example | | | | |
|---|---|---|---|---|---|---|---|---|---|
| | | | 19 | 20 | 1 | 2 | 3 | 4 | 5 |
| Aqueous coating composition | | | X-19 | X-20 | X-21 | X-22 | X-23 | X-24 | X-25 |
| Film- | Hydroxy- | Water-dispersible | 100 | 100 | 100 | 100 | 100 | 100 | 100 |
| forming | containing | hydroxy-containing | | | | | | | |
| resin (D) | acrylic resin | acrylic resin water | | | | | | | |
| | (D1) | dispersion (D1-1) | | | | | | | |
| | Hydroxy- | Hydroxy-containing | 44 | 44 | 44 | 44 | 44 | 44 | 44 |
| | containing | polyester resin | | | | | | | |
| | polyester | solution (D2-1) | | | | | | | |
| | resin (D2) | | | | | | | | |
| Curing | Melamine | Melamine resin | 50 | 50 | 50 | 50 | 50 | 50 | 50 |
| agent (E) | resin | (E-1) | | | | | | | |

| | | | | | | | | |
|---|---|---|---|---|---|---|---|---|
| Aluminium pigment | Type | PA-4 | PA-1 | PA-1 | PA-1 | PA-1 | PA-1 | PA-10 |
| dispersion | Quantity | 197 | 60 | 60 | 60 | 60 | 60 | 59 |
| Pigment dispersion | Type | PB-1 | PB-8 | PB-1 | PB-5 | PB-7 | PB-1 | PB-1 |
| | Quantity | 29 | 33 | 29 | 29 | 29 | 29 | 29 |
| Resin composition | Type | C-1 | C-1 | | | | C-11 | C-1 |
| | Quantity | 16.0 | 1.0 | | | | 0.5 | 1.0 |

### Production of Substrates to be Coated

### Production Example 36

A thermosetting epoxy resin cationic electrodeposition coating composition (product name “Electron GT-10”, manufactured by Kansai Paint Co., Ltd.) was applied by electrodeposition to a zinc phosphate-treated cold-rolled steel plate (30 cm×45 cm) to a film thickness of 20 μm, and cured by heating at 170° C. for 30 minutes. Subsequently, an intermediate coating composition (product name “TP-65-2”, manufactured by Kansai Paint Co., Ltd., a polyester resin/amino resin organic solvent-type coating composition) was applied to this electrodeposition coating film to a film thickness of 35 μm, and cured by heating at 140° C. for 30 minutes. Thereby, a substrate comprising a steel plate, and an electrodeposition coating film and an intermediate coating film formed on the steel plate was prepared.

### Method of Forming Coating Films

### Example 21

A multilayer coating film comprising a base coating film and a clear coating film on a substrate was formed by using the aqueous coating composition (X-1) obtained in Example 1 as a coating material for forming a base coating film in the two-coat one-bake method in method I of forming coating films.

Specifically, the aqueous coating composition (X-1) immediately after being produced was applied to the substrate obtained in Production Example 36 to a film thickness of 15 μm using a rotary atomization-type bell-shaped coating device, then allowed to stand for 2 minutes, and preheated at 80° C. for 3 minutes. Subsequently, an acrylic resin organic solvent-based top clear coating composition (product name “Magicron KINO-1210”, manufactured by Kansai Paint Co., Ltd.) was applied to the uncured coated surface to a film thickness of 40 μm, then allowed to stand for 7 minutes, and heated at 140° C. for 30 minutes to simultaneously cure both coating films. Thereby, a test panel consisting of a substrate and a multilayer coating film comprising a base coating film and a clear coating film formed on the substrate was obtained.

A test panel on which the aqueous coating composition (X-1) after being stored was applied was obtained in the same manner as described above, except that the aqueous coating composition (X-1), which had been stored at 40° C. for 10 days, was used in place of the aqueous coating composition (X-1) immediately after being produced.

### Examples 22 to 40 and Comparative Examples 6 to 10

Test panels of Examples 22 to 40 and Comparative Examples 6 to 10 were obtained in the same manner as in Example 21, except that the aqueous coating compositions shown in Table 5 were used in place of the aqueous coating composition (X-1).

### Evaluation Test 1

### Coating Film Performance Test

Storage stability (color difference): The test panels on which the aqueous coating compositions immediately after being produced were applied, and the test panels on which the aqueous coating compositions that had been stored at 40° C. for 10 days after production were applied, obtained in Examples 21 to 40 and Comparative Examples 6 to 10 were tested using a multi-angle spectrocolorimeter “CM-512m3” (manufactured by Konica Minolta) by irradiating the test panels with light from an angle of 75° relative to the axis perpendicular to the coating film face, and subjecting light oriented perpendicularly to the coating film face among reflected lights to colorimetry to determine its L*, a*, b* values, calculating a color difference ΔE* (JIS K 5600-4-6 (1999)) between the test panels. The smaller the ΔE*, the smaller the change in color due to storage, and the higher the storage stability of the coating composition. For example, in terms of practical use, ΔE* is preferably 1.5 or lower, and more preferably 1 or lower.

Storage stability (gas yield): 150 g of each of the aqueous coating compositions (X-1) to (X-25) obtained in Examples 1 to 20 and Comparative Examples 1 to 5 was placed at the bottom of a 300-ml Erlenmeyer flask, and the Erlenmeyer flask was allowed to stand for about 1 hour in a thermostatic room at 40° C. until the temperature remained constant. A measuring pipette was inserted at the center of this Erlenmeyer flask approximately perpendicularly, and was retained in such a manner that the lower end of the measuring pipette was dipped into the aqueous coating composition and positioned about 5 mm above the bottom of the flask. The portion between the outer circumferential surface of the measuring pipette and the inner circumferential surface of the open portion of the Erlenmeyer flask was tightly sealed with, for example, a cork stopper, and the inside passage of the measuring pipette was left in communication with the outside. In this state, the flask was stored at 40° C. for 10 days, and the volume of aqueous coating composition in the measuring pipette pushed up by the pressure of gas generated during storage was read from the scale of the pipette. Table 5 shows the results.

### Coating Film Performance Test

Among the test panels obtained in Examples 21 to 40 and Comparative Examples 6 to 10, the test panels on which the aqueous coating compositions immediately after being produced were applied were evaluated for smoothness, DOI, flip-flop property, metallic mottling, and water resistance. The test methods are as follows:

Smoothness: Smoothness was evaluated for each test panel based on the Long Wave (LW) values measured by “Wave Scan” (product name, manufactured by BYK-Gardner). The lower the LW value, the higher the smoothness of the coated surface.

DOI: DOI was evaluated for each test panel based on the Short Wave (SW) values measured by “Wave Scan”. The smaller the SW value, the higher the DOI on the coated surface.

Flip-flop property: Each test panel was observed visually from various angles, and the flip-flop property was rated according to the following criteria.

A: Variation of the brightness depending on the angle of viewing is significantly high (extremely excellent flip-flop property).

B: Variation of the brightness depending on the angle of viewing is high (excellent flip-flop property).

C: Variation of the brightness depending on the angle of viewing is slightly low (slightly poor flip-flop property).

D: Variation of the brightness depending on the angle of viewing is low (poor flip-flop property).

Metallic mottling: Each test panel was visually observed, and the degree of occurrence of metallic mottling was evaluated according to the following criteria:

A: Substantially no metallic mottling was observed, and the coating film has an extremely excellent appearance.

B: A small amount of metallic mottling was observed, but the coating film has an excellent appearance.

C: Metallic mottling was observed, and the coating film has a slightly poor appearance.

D: A considerable amount of metallic mottling was observed, and the coating film has a poor appearance.

Water resistance: Each test panel was immersed in 40° C. warm water for 240 hours, then removed and dried at 20° C. for 12 hours. Subsequently, cross-cuts reaching the substrate were made in the multilayer coating film on the test panel using a cutter knife to form a grid of 100 squares (2 mm×2 mm). Afterwards, an adhesive cellophane tape was applied to the surface of the grid portion, and abruptly peeled off at 20° C. The condition of the remaining coating film squares was then checked. The water resistance was evaluated according to the following criteria:

A: 100 squares remained, and no edge chipping occurred.

B: 100 squares remained, but edge chipping occurred.

C: 90 to 99 squares remained.

D: The number of remaining squares was 89 or less.

Comprehensive evaluation: For aqueous coating compositions in the field to which the present invention pertains, all of the storage stability, smoothness, DOI, flip-flop property, metallic mottling, and water resistance are desirably excellent. Accordingly, the comprehensive evaluation was conducted according to the following criteria:

A: The storage stability (ΔE*) is 1.5 or lower, the storage stability (gas yield) is 5 (mL) or lower, the smoothness (LW value) is 20 or lower, DOI (SW value) is 12 or lower, and all of the flip-flop property, metallic mottling, and water resistance are A.

B: The storage stability (ΔE*) is 1.5 or lower, the storage stability (gas yield) is 5 (mL) or lower, the smoothness (LW value) is 20 or lower, DOI (SW value) is 12 or lower, and each of the flip-flop property, metallic mottling, and water resistance is either A or B, with at least one of them being B.

C: The storage stability (ΔE*) is 1.5 or lower, the storage stability (gas yield) is 5 (mL) or lower, the smoothness (LW value) is 20 or lower, DOI (SW value) is 12 or lower, and each of the flip-flop property, metallic mottling, and water resistance is A, B, or C, with at least one of them being C.

D: The storage stability (ΔE*) is higher than 1.5, the storage stability (gas yield) is higher than 5 (mL), the smoothness (LW value) is higher than 20, DOI (SW value) is higher than 12, or at least one of the flip-flop property, metallic mottling, and water resistance is D.

Table 5 shows the results of the evaluation test.

TABLE 5

| | | | Storage | | | | | | | |
|---|---|---|---|---|---|---|---|---|---|---|
| | | Aqueous | stability | | Appearance | | | | | |
| | | coating | | Gas yield | | | Flip-flop | Metallic | Water | Comprehensive |
| | | composition | ΔE* | [mL] | Smoothness | DOI | property | mottling | resistance | evalution |
| Example | 21 | X-1 | 0.5 | 1 | 12 | 8 | A | A | A | A |
| | 22 | X-2 | 0.6 | 2 | 12 | 8 | A | A | A | A |
| | 23 | X-3 | 0.6 | 1 | 12 | 8 | A | A | A | A |
| | 24 | X-4 | 0.7 | 1 | 12 | 8 | A | A | A | A |
| | 25 | X-5 | 0.6 | 1 | 12 | 8 | A | A | A | A |
| | 26 | X-6 | 0.6 | 1 | 12 | 8 | A | A | A | A |
| | 27 | X-7 | 0.6 | 1 | 12 | 8 | A | A | B | B |
| | 28 | X-8 | 0.7 | 1 | 12 | 8 | A | A | A | A |
| | 29 | X-9 | 0.6 | 1 | 12 | 8 | A | A | A | A |
| | 30 | X-10 | 0.7 | 1 | 12 | 8 | A | A | A | A |
| | 31 | X-11 | 0.6 | 1 | 12 | 8 | A | A | A | A |
| | 32 | X-12 | 0.6 | 1 | 12 | 8 | A | A | A | A |
| | 33 | X-13 | 0.3 | 1 | 12 | 10 | B | A | A | B |
| | 34 | X-14 | 0.6 | 1 | 12 | 8 | A | A | A | A |
| | 35 | X-15 | 0.3 | 1 | 12 | 8 | A | A | A | A |
| | 36 | X-16 | 0.3 | 1 | 12 | 8 | A | A | A | A |
| | 37 | X-17 | 0.3 | 1 | 12 | 8 | A | A | A | A |
| | 38 | X-18 | 0.4 | 1 | 12 | 6 | B | A | A | B |
| | 39 | X-19 | 0.4 | 4 | 13 | 10 | B | B | B | B |
| | 40 | X-20 | 0.7 | 1 | 12 | 8 | A | A | A | A |
| Comparative | 6 | X-21 | 2.0 | 1 | 12 | 8 | B | A | A | D |
| Example | 7 | X-22 | 1.6 | 1 | 12 | 8 | B | A | A | D |
| | 8 | X-23 | 1.7 | 1 | 12 | 8 | B | A | A | D |
| | 9 | X-24 | 1.9 | 1 | 12 | 8 | B | B | B | D |
| | 10 | X-25 | 0.6 | 15 | 12 | 8 | B | B | B | D |

### Production Examples 37 to 40

Synthesis was carried out in the same manner as in Production Example 15, except that the composition shown in Table 6 was used, thereby obtaining water-dispersible hydroxy-containing acrylic resin water dispersions (D1-3) to (D1-6).

Table 6 shows the composition of raw materials (parts), solids content (%), acid value (mg KOH/g), and hydroxy value (mg KOH/g) of the water-dispersible hydroxy-containing acrylic resin water dispersions (D1-3) to (D1-6).

In Table 6, methylene bisacrylamide and allyl methacrylate in the monomer emulsion for the core portion are polymerizable unsaturated monomers having two polymerizable unsaturated groups in one molecule. Further, styrene and 2-ethylhexyl acrylate in the monomer emulsion for the shell portion are hydrophobic polymerizable unsaturated monomers.

TABLE 6

| Production Example | | 37 | 38 | 39 | 40 |
|---|---|---|---|---|---|
| Water-dispersible hydroxy- | | D1-3 | D1-4 | D1-5 | D1-6 |
| containing acrylic resin | | | | | |
| Deionized water | | 128 | 128 | 128 | 128 |
| “Adekaria Soap SR-1025” | | 2 | 2 | 2 | 2 |
| 6% ammonium persulfate aqueous solution | | 5.3 | 5.3 | 5.3 | 5.3 |
| Monomer | Deionized water | 40 | 40 | 40 | 40 |
| emulsion for | “Adekaria Soap SR-1025” | 2.8 | 2.8 | 2.8 | 2.8 |
| the core | Methylene bisacrylamide | 2.1 | | | |
| portion | Allylmethacrylate | | 2.1 | | 2.1 |
| | Acrylamide | | | 2.1 | |
| | Styrene | 2.8 | 2.8 | 2.8 | 2.8 |
| | Methylmethacrylate | 16.1 | 16.1 | 16.1 | 16.1 |
| | Ethylacrylate | 28 | 28 | 28 | 28 |
| | n-butylacrylate | 21 | 21 | 21 | 21 |
| Monomer | Deionized water | 17 | 17 | 17 | 17 |
| emulsion for | “Adekaria Soap SR-1025” | 1.2 | 1.2 | 1.2 | 1.2 |
| the shell | Ammonium persulfate | 0.03 | 0.03 | 0.03 | 0.03 |
| portion | Styrene | | 3 | | |
| | 2-ethylhexylacrylate | 3 | | 3 | |
| | 2-hydroxyethylacrylate | 5.1 | 5.1 | 5.1 | 5.1 |
| | Methacrylic acid | 5.1 | 5.1 | 5.1 | 5.1 |
| | Methylmethacrylate | 6 | 6 | 6 | 9 |
| | Ethylacrylate | 1.8 | 1.8 | 1.8 | 1.8 |
| | n-butylacrylate | 9 | 9 | 9 | 9 |

| | | | | |
|---|---|---|---|---|
| 5% 2-(dimethylamino)ethanol aqueous solution | 40 | 40 | 40 | 40 |
| Solids content (%) | 30 | 30 | 30 | 30 |
| Acid value (mgKOH/g) | 33 | 33 | 33 | 33 |
| Hydroxy value (mgKOH/g) | 25 | 25 | 25 | 25 |

Further, among the water-dispersible hydroxy-containing acrylic resins (D1-3) to (D1-6) in Table 6, (D1-3) to (D1-4) correspond to a core-shell-type water-dispersible hydroxy-containing acrylic resin (D1′).

### Production Example 41

113 parts of trimethylolpropane, 131 parts of neopentyl glycol, 80 parts of 1,2-cyclohexanedicarboxylic acid anhydride, 93 parts of isophthalic acid and 91 parts of adipic acid were placed into a reaction vessel equipped with a thermometer, a thermostat, a stirring device, a reflux condenser, and a water separator. The mixture was heated to a range of 160° C. to 230° C. over 3 hours, followed by a condensation reaction at 230° C. for 4 hours. Subsequently, to introduce a carboxy group to the obtained condensation reaction product, 33.5 parts of trimellitic anhydride was added to the product, followed by a reaction at 170° C. for 30 minutes. Thereafter, the product was diluted with 2-ethyl-1-hexanol (mass that dissolves in 100 g of water at 20° C.: 0.1 g), thereby obtaining a hydroxy-containing polyester resin solution (D2-2) having a solids content of 70%. The obtained hydroxy-containing polyester resin had an acid value of 40 mg KOH/g, a hydroxy value of 161 mg KOH/g, and a number average molecular weight of 1,300. In the composition of raw materials, the total content of alicyclic polybasic acid in the acid component was 28 mol % based on the total amount of the acid component.

### Production Example 42

A hydroxy-containing polyester resin solution (D2-3) was obtained in the same manner as in Production Example 17, except that ethylene glycol mono-n-butyl ether (the mass that dissolves in 100 g of water at 20° C.: unlimited) was used as a dilution solvent in place of 2-ethyl-1-hexanol.

### Production of Pigment Dispersion Solution

### Production Example 43

In a stirring and mixing container, 22 parts of (solids content: 12 parts) of the hydroxy-containing acrylic resin solution (D1-2) obtained in Production Example 16, 18 parts of “HOSTAPERM RED P2GL-WD” (product name, manufactured by CLARIANT; perylene pigment, C.I. Pigment Red 179), and 54 parts of deionized water were uniformly mixed. Further, 2-(dimethylamino)ethanol was added thereto, and the pH of the mixture was adjusted to 7.5. The obtained mixture was then placed into a wide-mouthed glass bottle having a capacity of 225 ml. Glass beads having a diameter of about 1.3 mm were added to the bottle as a dispersion medium, which was then hermetically sealed, and the mixture was dispersed for 4 hours by a paint shaker, producing a pigment dispersion (PB-9).

### Production Examples 44 to 49

Pigment dispersions (PB-10) to (PB-15) were obtained in the same manner as in Production Example 43, except that the formulation composition shown in Table 7 was used.

TABLE 7

| | | Production Example | | | | | | |
|---|---|---|---|---|---|---|---|---|
| | | 43 | 44 | 45 | 46 | 47 | 48 | 49 |
| Pigment dispersion | | PB-9 | PB-10 | PB-11 | PB-12 | PB-13 | PB-14 | PB-15 |
| Hydroxy-containing acrylic resin solution (D1-2) | | 22 | 22 | 22 | 22 | 22 | 22 | 22 |
| Organic | “HOSTAPERM RED P2GL-WD” | 18 | | | 29 | | | |
| pigment (B) | “PALIOGEN RED L3885” (Note 8) | | 18 | | | | | |
| having two | “PERRINDO MAROON 179 229-6438” (Note | | | 18 | | | | |
| or more | 9) | | | | | | | |
| ketone | “PALIOGEN BLUE L-6480” (Note 10) | | | | | 18 | | |
| structures | “MONOLITE BLUE 3R” (Note 11) | | | | | | 18 | |
| in one | “CROMOPHTAL BLUE A3R” (Note 12) | | | | | | | 18 |
| molecule | | | | | | | | |

| | | | | | | | |
|---|---|---|---|---|---|---|---|
| Deionized water | 54 | 54 | 54 | 54 | 54 | 54 | 54 |

(Note 8) “PALIOGEN RED L3885” (product name, manufactured by BASF; perylene pigment, C.I. Pigment Red 179)
(Note 9) “PERRINDO MAROON 179 229-6438” (product name, manufactured by Sun Chemical; perylene pigment, C.I. Pigment Red 179)
(Note 10) “PALIOGEN BLUE L-6480” (product name, manufactured by BASF; threne pigment, C.I. Pigment Blue 60)
(Note 11) “MONOLITE BLUE 3R” (product name, manufactured by HEUBACH; threne pigment, C.I. Pigment Blue 60)
(Note 12) “CROMOPHTAL BLUE A3R” (product name, manufactured by Ciba; threne pigment, C.I. Pigment Blue 60)

### Production of Aqueous Coating Composition

### Example 41

Added to a stirring and mixing container were: 100 parts of the water-dispersible hydroxy-containing acrylic resin water dispersion (D1-1) obtained in Production Example 15, 40 parts of the hydroxy-containing polyester resin solution (D2-1) obtained in Production Example 17, 50 parts of the melamine resin (E-1) (methyl-butyl mixed etherified melamine resin; the solids content is 60%, the weight average molecular weight is 2,000), 60 parts of the aluminium pigment dispersion (PA-1) obtained in Production Example 18, 26 parts of the pigment dispersion (PB-9) obtained in Production Example 43, and 10 parts of the resin composition (C-1) obtained in Production Example 4; and the mixture was uniformly mixed. Further, “Primal ASE-60” (product name, manufactured by Rohm and Haas; polyacrylic acid thickener), 2-(dimethylamino)ethanol, and deionized water were added, thereby obtaining an aqueous coating composition (X-26) having a pH of 8.0, a solids content of 24%, and a viscosity of 50 seconds as measured at 20° C. using Ford Cup No. 4.

### Examples 42 to 75 and Comparative Examples 11 to 16

Aqueous coating compositions (X-27) to (X-60) and (X-63) to (X-68) having a pH of 8.0, a solids content of 25%, and a viscosity of 50 seconds as measured at 20° C. using Ford Cup No. 4 were obtained in the same as in Example 41, except that the formulation composition shown in Table 8 was used.

### Example 76

Added to a stirring and mixing container were: 100 parts of the water-dispersible hydroxy-containing acrylic resin water dispersion (D1-1) obtained in Production Example 15, 40 parts of the hydroxy-containing polyester resin solution (D2-1) obtained in Production Example 17, 50 parts of the melamine resin (E-1) (methyl-butyl mixed etherified melamine resin; the solids content is 60%, the weight average molecular weight is 2,000), 60 parts of the aluminium pigment dispersion (PA-9) obtained in Production Example 26, 26 parts of the pigment dispersion (PB-9) obtained in Production Example 43, and 10 parts of the resin composition (C-1) obtained in Production Example 4; and the mixture was uniformly mixed. Further, “UH-752” (product name, manufactured by ADEKA, associative thickener), 2-(dimethylamino)ethanol, and deionized water were added, thereby obtaining an aqueous coating composition (X-61) having a pH of 8.0, a solids content of 24%, and a viscosity of 50 seconds as measured at 20° C. using Ford Cup No. 4.

### Example 77

Added to a stirring and mixing container were: 100 parts of the water-dispersible hydroxy-containing acrylic resin water dispersion (D1-1) obtained in Production Example 15, 40 parts of the hydroxy-containing polyester resin solution (D2-1) obtained in Production Example 17, 50 parts of the melamine resin (E-1) (methyl-butyl mixed etherified melamine resin; the solids content is 60%, the weight average molecular weight is 2,000), 60 parts of the aluminium pigment dispersion (PA-1) obtained in Production Example 18, 26 parts of the pigment dispersion (PB-9) obtained in Production Example 43, and 10 parts of the resin composition (C-1) obtained in Production Example 4; and the mixture was uniformly mixed. Further, 2-(dimethylamino)ethanol and deionized water were added, thereby obtaining an aqueous coating composition (X-62) having a pH of 8.0 and a viscosity of 50 seconds as measured at 20° C. using Ford Cup No. 4.

TABLE 8

| | | | Example | | | | | | | | | | |
|---|---|---|---|---|---|---|---|---|---|---|---|---|---|
| | | | 41 | 42 | 43 | 44 | 45 | 46 | 47 | 48 | 49 | 50 | 51 |
| Aqueous coating composition | | | X-26 | X-27 | X-28 | X-29 | X-30 | X-31 | X-32 | X-33 | X-34 | X-35 | X-36 |
| Film- | Hydroxy- | Water-dispersible | 100 | 100 | 100 | 100 | 100 | 100 | 100 | 100 | 100 | 100 | 100 |
| forming | containing | hydroxy- | | | | | | | | | | | |
| resin (D) | acrylic | containing acrylic | | | | | | | | | | | |
| | resin (D1) | resin water | | | | | | | | | | | |
| | | dispersion (D1-1) | | | | | | | | | | | |
| | Hydroxy- | Hydroxy- | 40 | 40 | 40 | 40 | 40 | 40 | 40 | 40 | 40 | 40 | 40 |
| | containing | containing | | | | | | | | | | | |
| | polyester | polyester resin | | | | | | | | | | | |
| | resin (D2) | solution (D2-1) | | | | | | | | | | | |
| Curing | Melamine | Melamine resin | 50 | 50 | 50 | 50 | 50 | 50 | 50 | 50 | 50 | 50 | 50 |
| agent (E) | resin | (E-1) | | | | | | | | | | | |

| | | | | | | | | | | | | |
|---|---|---|---|---|---|---|---|---|---|---|---|---|
| Aluminium pigment | Type | PA-1 | PA-2 | PA-1 | PA-1 | PA-1 | PA-1 | PA-1 | PA-1 | PA-1 | PA-1 | PA-1 |
| dispersion | Quantity | 60 | 62 | 60 | 60 | 60 | 60 | 60 | 60 | 60 | 60 | 60 |
| Pigment dispersion | Type | PB-9 | PB-9 | PB-9 | PB-9 | PB-9 | PB-9 | PB-9 | PB-9 | PB-9 | PB-9 | PB-9 |
| | Quantity | 26 | 26 | 26 | 26 | 26 | 26 | 26 | 26 | 26 | 26 | 26 |
| Resin composition | Type | C-1 | C-1 | C-2 | C-3 | C-4 | C-5 | C-6 | C-7 | C-8 | C-9 | C-10 |
| | Quantity | 10 | 8 | 10 | 10 | 10 | 10 | 10 | 10 | 10 | 10 | 10 |

| | | | Example | | | | | | | | | | |
|---|---|---|---|---|---|---|---|---|---|---|---|---|---|
| | | | 52 | 53 | 54 | 55 | 56 | 57 | 58 | 59 | 60 | 61 | 62 |
| Aqueous coating composition | | | X-37 | X-38 | X-39 | X-40 | X-41 | X-42 | X-43 | X-44 | X-45 | X-46 | X-47 |
| Film- | Hydroxy- | Water-dispersible | 100 | 100 | 100 | 100 | 100 | 100 | 100 | 100 | 100 | 100 | 100 |
| forming | containing | hydroxy- | | | | | | | | | | | |
| resin (D) | acrylic | containing acrylic | | | | | | | | | | | |
| | resin (D1) | resin water | | | | | | | | | | | |
| | | dispersion (D1-1) | | | | | | | | | | | |
| | Hydroxy- | Hydroxy- | 40 | 40 | 40 | 40 | 40 | 40 | 40 | 40 | 40 | 40 | 40 |
| | containing | containing | | | | | | | | | | | |
| | polyester | polyester resin | | | | | | | | | | | |
| | resin (D2) | solution (D2-1) | | | | | | | | | | | |
| Curing | Melamine | Melamine resin | 50 | 50 | 50 | 50 | 50 | 50 | 50 | 50 | 50 | 50 | 50 |
| agent (E) | resin | (E-1) | | | | | | | | | | | |

| | | | | | | | | | | | | |
|---|---|---|---|---|---|---|---|---|---|---|---|---|
| Aluminium pigment | Type | PA-3 | PA-4 | PA-1 | PA-1 | PA-5 | PA-1 | PA-1 | PA-1 | PA-1 | PA-1 | PA-1 |
| dispersion | Quantity | 45 | 197 | 60 | 60 | 62 | 60 | 60 | 60 | 60 | 60 | 60 |
| Pigment dispersion | Type | PB-10 | PB-11 | PB-12 | PB-13 | PB-13 | PB-13 | PB-13 | PB-13 | PB-13 | PB-13 | PB-13 |
| | Quantity | 26 | 26 | 29 | 26 | 26 | 26 | 26 | 26 | 26 | 26 | 26 |
| Resin composition | Type | C-1 | C-1 | C-1 | C-1 | C-1 | C-2 | C-3 | C-4 | C-5 | C-6 | C-7 |
| | Quantity | 1.4 | 24 | 10 | 10 | 6 | 10 | 10 | 10 | 10 | 10 | 10 |

| | | | Example | | | | | | | | | | |
|---|---|---|---|---|---|---|---|---|---|---|---|---|---|
| | | | 63 | 64 | 65 | 66 | 67 | 68 | 69 | 70 | 71 | 72 | 73 |
| Aqueous coating composition | | | X-48 | X-49 | X-50 | X-51 | X-52 | X-53 | X-54 | X-55 | X-56 | X-57 | X-58 |
| Film- | Hydroxy- | Water-dispersible | 100 | 100 | 100 | 100 | 100 | | | | | 100 | 100 |
| forming | containing | hydroxy-containing | | | | | | | | | | | |
| resin (D) | acrylic | acrylic resin water | | | | | | | | | | | |
| | resin (D1) | dispersion (D1-1) | | | | | | | | | | | |
| | | Water-dispersible | | | | | | 100 | | | | | |
| | | hydroxy-containing | | | | | | | | | | | |
| | | acrylic resin water | | | | | | | | | | | |
| | | dispersion (D1-3) | | | | | | | | | | | |
| | | Water-dispersible | | | | | | | 100 | | | | |
| | | hydroxy-containing | | | | | | | | | | | |
| | | acrylic resin water | | | | | | | | | | | |
| | | dispersion (D1-4) | | | | | | | | | | | |
| | | Water-dispersible | | | | | | | | 100 | | | |
| | | hydroxy-containing | | | | | | | | | | | |
| | | acrylic resin water | | | | | | | | | | | |
| | | dispersion (D1-5) | | | | | | | | | | | |
| | | Water-dispersible | | | | | | | | | 100 | | |
| | | hydroxy-containing | | | | | | | | | | | |
| | | acrylic resin water | | | | | | | | | | | |
| | | dispersion (D1-6) | | | | | | | | | | | |
| | Hydroxy- | Hydroxy- | 40 | 40 | 40 | 40 | 40 | 40 | 40 | 40 | 40 | | |
| | containing | containing | | | | | | | | | | | |
| | polyester | polyester resin | | | | | | | | | | | |
| | resin (D2) | solution (D2-1) | | | | | | | | | | | |
| | | Hydroxy- | | | | | | | | | | 40 | |
| | | containing | | | | | | | | | | | |
| | | polyester resin | | | | | | | | | | | |
| | | solution (D2-2) | | | | | | | | | | | |
| | | Hydroxy- | | | | | | | | | | | 40 |
| | | containing | | | | | | | | | | | |
| | | polyester resin | | | | | | | | | | | |
| | | solution (D2-3) | | | | | | | | | | | |
| Curing | Melamine | Melamine resin | 50 | 50 | 50 | 50 | 50 | 50 | 50 | 50 | 50 | 50 | 50 |
| agent (E) | resin | (E-1) | | | | | | | | | | | |

| | | | | | | | | | | | | |
|---|---|---|---|---|---|---|---|---|---|---|---|---|
| Aluminium pigment | Type | PA-1 | PA-1 | PA-1 | PA-6 | PA-7 | PA-1 | PA-1 | PA-1 | PA-1 | PA-1 | PA-8 |
| dispersion | Quantity | 60 | 60 | 60 | 98 | 137 | 60 | 60 | 60 | 60 | 60 | 60 |
| Pigment dispersion | Type | PB-13 | PB-13 | PB-13 | PB-14 | PB-15 | PB-9 | PB-9 | PB-9 | PB-9 | PB-9 | PB-9 |
| | Quantity | 26 | 26 | 26 | 26 | 26 | 26 | 26 | 26 | 26 | 26 | 26 |
| Resin composition | Type | C-8 | C-9 | C-10 | C-2 | C-2 | C-1 | C-1 | C-1 | C-1 | C-1 | C-1 |
| | Quantity | 10 | 10 | 10 | 14 | 18 | 10 | 10 | 10 | 10 | 10 | 10 |

| | | | Example | | | | Comparative Example | | | | | |
|---|---|---|---|---|---|---|---|---|---|---|---|---|
| | | | 74 | 75 | 76 | 77 | 11 | 12 | 13 | 14 | 15 | 16 |
| Aqueous coating composition | | | X-59 | X-60 | X-61 | X-62 | X-63 | X-64 | X-65 | X-66 | X-67 | X-68 |
| Film- | Hydroxy- | Water-dispersible | 100 | 100 | 100 | 100 | 100 | 100 | 100 | 100 | 100 | 100 |
| forming | containing | hydroxy- | | | | | | | | | | |
| resin (D) | acrylic resin | containing acrylic | | | | | | | | | | |
| | (D1) | resin water | | | | | | | | | | |
| | | dispersion (D1-1) | | | | | | | | | | |
| | Hydroxy- | Hydroxy- | 40 | 40 | 40 | 40 | 40 | 40 | 40 | 40 | 40 | 40 |
| | containing | containing | | | | | | | | | | |
| | polyester | polyester resin | | | | | | | | | | |
| | resin (D2) | solution (D2-1) | | | | | | | | | | |
| Curing | Melamine | Melamine resin | | 40 | 50 | 50 | 50 | 50 | 50 | 50 | 50 | 50 |
| agent (E) | resin | (E-1) | | | | | | | | | | |
| | | Melamine resin | 38 | | | | | | | | | |
| | | (E-2) (Note 13) | | | | | | | | | | |
| | Blocked | “Bayhydur VP | | 16 | | | | | | | | |
| | polyisocyanate | LS-2310” (Note | | | | | | | | | | |
| | compound | 14) | | | | | | | | | | |

| | | | | | | | | | | | |
|---|---|---|---|---|---|---|---|---|---|---|---|
| Aluminium pigment | Type | PA-1 | PA-1 | PA-9 | PA-1 | PA-1 | PA-1 | PA-10 | PA-1 | PA-1 | PA-10 |
| dispersion | Quantity | 60 | 60 | 60 | 60 | 60 | 60 | 59 | 60 | 60 | 59 |
| Pigment dispersion | Type | PB-9 | PB-9 | PB-9 | PB-9 | PB-9 | PB-9 | PB-9 | PB-13 | PB-13 | PB-13 |
| | Quantity | 26 | 26 | 26 | 26 | 26 | 26 | 26 | 26 | 26 | 26 |
| Resin composition | Type | C-1 | C-1 | C-1 | C-1 | | C-11 | C-1 | | C-11 | C-1 |
| | Quantity | 10 | 10 | 10 | 10 | | 10 | 10 | | 10 | 10 |

(Note 13) Melamine resin (E-2): methyl etherified melamine resin; the solids content is 80%; the weight average molecular weight is 800.
(Note 14) “Bayhydur VP LS-2310”: product name, manufactured by Sumitomo Bayer Urethane Co. Ltd., blocked polyisocyanate compound; the solids content is 38%.

### Method of Forming Coating Films

### Example 78

A multilayer coating film comprising a base coating film and a clear coating film on a substrate was formed by using the aqueous coating composition (X-26) obtained in Example 41 as a coating material for forming a base coat in the two-coat one-bake method in method I of forming coating films.

Specifically, the aqueous coating composition (X-26) immediately after being produced was applied to the substrate obtained in Production Example 36 to a film thickness of 15 μm using a rotary atomization-type bell-shaped coating device, then allowed to stand for 2 minutes, and preheated at 80° C. for 3 minutes. Subsequently, an acrylic resin organic solvent-based top clear coating composition (product name “Magicron KINO-1210”, manufactured by Kansai Paint Co., Ltd.) was applied to the uncured coated surface to a film thickness of 40 μm, then allowed to stand for 7 minutes, and heated at 140° C. for 30 minutes to simultaneously cure both coating films. Thereby, a test panel consisting of a substrate and a multilayer coating film comprising a base coating film and a clear coating film formed on the substrate was obtained.

A test panel on which the aqueous coating composition (X-26) after being stored was applied was obtained in the same manner as described above, except that the aqueous coating composition (X-26), which had been stored at 40° C. for 10 days, was used in place of the aqueous coating composition (X-26) immediately after being produced.

### Examples 79 to 114 and Comparative Examples 17 to 22

Test panels of Examples 79 to 114 and Comparative Examples 17 to 22 were obtained in the same manner as in Example 78, except that the aqueous coating compositions shown in Table 9 were used in place of the aqueous coating composition (X-26).

### Evaluation Test 2

Each test panel was tested for storage stability, smoothness, DOI, flip-flop property, metallic mottling, water resistance, and comprehensive evaluation in the same manner as in “Evaluation Test 1” described above, except that the aqueous coating compositions (X-26) to (X-68) were used.

Table 9 shows the results of the evaluation test.

TABLE 9

| | | | Storage | | | | | | | |
|---|---|---|---|---|---|---|---|---|---|---|
| | | Aqueous | stability | | Appearance | | | | | |
| | | coating | | Gas yield | | | Flip-flop | Metallic | Water | Comprehensive |
| | | composition | ΔE* | [mL] | Smoothness | DOI | property | mottling | resistance | evaluation |
| Example | 78 | X-26 | 0.7 | 1 | 10 | 6 | A | A | A | A |
| | 79 | X-27 | 0.8 | 2 | 10 | 6 | A | A | A | A |
| | 80 | X-28 | 0.8 | 1 | 10 | 6 | A | A | A | A |
| | 81 | X-29 | 0.9 | 1 | 10 | 6 | A | A | A | A |
| | 82 | X-30 | 0.8 | 1 | 10 | 6 | A | A | A | A |
| | 83 | X-31 | 0.8 | 1 | 10 | 6 | A | A | A | A |
| | 84 | X-32 | 0.8 | 1 | 10 | 6 | A | A | B | B |
| | 85 | X-33 | 0.9 | 1 | 10 | 6 | A | A | A | A |
| | 86 | X-34 | 0.8 | 1 | 10 | 6 | A | A | A | A |
| | 87 | X-35 | 0.9 | 1 | 10 | 6 | A | A | A | A |
| | 88 | X-36 | 0.8 | 1 | 10 | 6 | A | A | A | A |
| | 89 | X-37 | 0.5 | 1 | 10 | 5 | B | A | A | B |
| | 90 | X-38 | 0.5 | 4 | 11 | 10 | B | B | B | B |
| | 91 | X-39 | 0.8 | 1 | 10 | 6 | A | A | A | A |
| | 92 | X-40 | 0.5 | 1 | 10 | 6 | A | A | A | A |
| | 93 | X-41 | 0.6 | 3 | 10 | 6 | A | A | A | A |
| | 94 | X-42 | 0.6 | 1 | 10 | 6 | A | A | A | A |
| | 95 | X-43 | 0.7 | 1 | 10 | 6 | A | A | A | A |
| | 96 | X-44 | 0.6 | 1 | 10 | 6 | A | A | A | A |
| | 97 | X-45 | 0.6 | 1 | 10 | 6 | A | A | A | A |
| | 98 | X-46 | 0.6 | 1 | 10 | 6 | A | A | B | B |
| | 99 | X-47 | 0.6 | 1 | 10 | 6 | A | A | A | A |
| | 100 | X-48 | 0.6 | 1 | 10 | 6 | A | A | A | A |
| | 101 | X-49 | 0.6 | 1 | 10 | 6 | A | A | A | A |
| | 102 | X-50 | 0.6 | 1 | 10 | 6 | A | A | A | A |
| | 103 | X-51 | 0.3 | 3 | 10 | 9 | B | B | A | B |
| | 104 | X-52 | 0.4 | 3 | 11 | 10 | B | B | B | B |
| | 105 | X-53 | 0.8 | 1 | 12 | 8 | A | B | A | B |
| | 106 | X-54 | 0.9 | 1 | 13 | 9 | A | B | A | B |
| | 107 | X-55 | 0.8 | 1 | 18 | 10 | B | B | B | B |
| | 108 | X-56 | 0.8 | 1 | 18 | 10 | B | B | B | B |
| | 109 | X-57 | 0.7 | 1 | 12 | 10 | A | A | A | A |
| | 110 | X-58 | 0.9 | 1 | 11 | 10 | B | B | A | B |
| | 111 | X-59 | 0.8 | 1 | 10 | 9 | A | A | B | B |
| | 112 | X-60 | 0.9 | 1 | 12 | 10 | A | A | A | A |
| | 113 | X-61 | 0.8 | 1 | 11 | 9 | A | A | A | A |
| | 114 | X-62 | 0.8 | 1 | 17 | 10 | B | B | A | B |
| Comparative | 17 | X-63 | 2.6 | 1 | 10 | 6 | B | B | B | D |
| Example | 18 | X-64 | 2.4 | 1 | 10 | 6 | B | B | B | D |
| | 19 | X-65 | 0.8 | 15 | 10 | 6 | B | B | B | D |
| | 20 | X-66 | 1.8 | 1 | 10 | 6 | B | B | B | D |
| | 21 | X-67 | 1.9 | 1 | 10 | 6 | B | B | B | D |
| | 22 | X-68 | 0.5 | 15 | 10 | 6 | B | B | B | D |

1. An aqueous coating composition, comprising:
(A) aluminium pigment treated with molybdic acid;
(B) condensed polycyclic pigment;
(C) resin having an aromatic ring with a nitro group bonded thereto; and
(D) film-forming resin,
wherein:
(B) condensed polycyclic pigment is (B1) phthalocyanine pigment or (B2) condensed polycyclic pigment having two or more ketone structures per molecule.

2. The aqueous coating composition according to claim 1, wherein the (B1) phthalocyanine pigment is at least one phthalocyanine pigment selected from the group consisting of α-copper phthalocyanine pigments, β-copper phthalocyanine pigments, ε-copper phthalocyanine pigments, and cobalt phthalocyanine pigments.

3. The aqueous coating composition according to claim 1, wherein the (B2) condensed polycyclic pigment having two or more ketone structures per molecule is an anthraquinone pigment and/or a perylene pigment.

4. The aqueous coating composition according to claim 1, wherein the (C) resin having an aromatic ring with a nitro group bonded thereto is a copolymer that is obtainable by copolymerization of monomer components comprising (a) polymerizable unsaturated monomer represented by Formula (1) below, 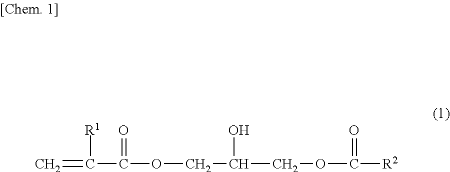
wherein R¹ represents a hydrogen atom or a methyl group; and R² represents an aromatic ring having a nitro group bonded thereto,
and (b) one or more other polymerizable unsaturated monomers.

5. The aqueous coating composition according to claim 4, wherein the (a) polymerizable unsaturated monomer is a polymerizable unsaturated monomer represented by Formula (2) below, 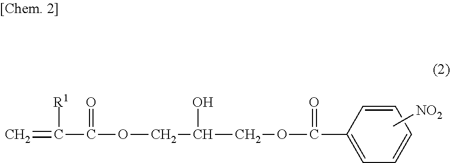
wherein R¹ represents a hydrogen atom or a methyl group.

6. The aqueous coating composition according to Item 4, wherein a mass ratio of the (a) polymerizable unsaturated monomer to the (b) one or more other polymerizable unsaturated monomers is in a range of from 5/95 to 60/40.

7. The aqueous coating composition according to claim 4, wherein the (b) one or more other polymerizable unsaturated monomers comprise, as a part thereof, a polymerizable unsaturated monomer having a polyoxyalkylene chain in an amount of 5 to 50 mass % based on the total amount of the (a) polymerizable unsaturated monomer and the (b) one or more other polymerizable unsaturated monomers.

8. The aqueous coating composition according to claim 1, wherein the proportion of the (A) aluminium pigment treated with molybdic acid is 0.1 to 80 parts by mass, the proportion of the (B) condensed polycyclic pigment is 0.01 to 40 parts by mass, and the proportion of the (C) resin having an aromatic ring with a nitro group bonded thereto is 0.1 to 30 parts by mass, all based on 100 parts by mass of the (D) film-forming resin.

9. The aqueous coating composition according to claim 1, further comprising (E) curing agent.

10. The aqueous coating composition according to claim 1, further comprising (F) phthalocyanine pigment derivative.

11. An article coated with the aqueous coating composition according to claim 1.

12. A method for forming a multilayer coating film, comprising the steps of:
(1) applying the aqueous coating composition of claim 1 to a substrate to form a base coating film;
(2) applying a clear coating composition on an uncured base coating film to form a clear coating film; and
(3) heating the uncured base coating film and an uncured clear coating film to simultaneously cure both coating films.

13. An article having a multilayer coating film formed by the method for forming a multilayer coating film of claim 12.
